(19) United States
(12) Patent Application Publication
(10) Pub. No.: US 2017/0284903 A1
(43) Pub. Date: Oct. 5, 2017

(54) MONITORING MACHINE HEALTH USING MULTIPLE SENSORS

(71) Applicant: SAS Institute Inc., Cary, NC (US)

(72) Inventors: THOMAS DALE ANDERSON, Peoria, AZ (US); JAMES EDWARD DUARTE, Clermont, FL (US); MILAD FALAHI, Mountain View, CA (US); MICHAEL JAMES LEONARD, Cary, NC (US); DAVID BRUCE ELSHEIMER, Clayton, NC (US)

(73) Assignee: SAS Institute Inc., Cary, NC (US)

(21) Appl. No.: 15/468,992

(22) Filed: Mar. 24, 2017

Related U.S. Application Data
(60) Provisional application No. 62/315,269, filed on Mar. 30, 2016.
(60) Provisional application No. 62/347,882, filed on Jun. 9, 2016.
(60) Provisional application No. 62/379,729, filed on Aug. 25, 2016.

(51) Int. Cl. G01M 99/00; F23N 5/24; G06N 5/02

(52) U.S. Cl. CPC G01M 99/008; G06N 5/022; F23N 5/242; F23N 2037/00

(57) ABSTRACT

Machine health can be monitored using multiple sensors. For example, a computing device can determine a target sensor to monitor from among multiple sensors associated with the machine. The computing device can determine magnitude values for a particular component of a time series associated with the target sensor. The computing device can generate a dataset including the magnitude values for the particular component of the time series and the sensor measurements from the multiple sensors. The computing device can generate a model using the dataset. The computing device can then receive additional sensor-measurements from the multiple sensors and use the model to determine a predicted magnitude-value for the particular component of the time series based on the additional sensor-measurements. The computing device can use the predicted magnitude-value to identify an anomaly with the machine.

### REFERENCE TO RELATED APPLICATION

This claims the benefit of priority under 35 U.S.C. §119(e) to U.S. Provisional Patent Application No. 62/315,269, titled “Early Detection Using Cycle Component Imitation” and filed Mar. 30, 2016, the benefit of priority under 35 U.S.C. §119(e) to U.S. Provisional Patent Application No. 62/347,882, titled “Early Detection Using Cycle Component Imitation” and filed Jun. 9, 2016, and the benefit of priority under 35 U.S.C. §119(e) to U.S. Provisional Patent Application No. 62/379,729, titled “Time Series Monitoring and Early Detection Using Cycle Component Imitation with Event Stream Processing” and filed Aug. 25, 2016, the entirety of each of which is hereby incorporated by reference herein.

### TECHNICAL FIELD

The present disclosure relates generally to a measurement system for diagnostic analysis of a machine. More specifically, but not by way of limitation, this disclosure relates to monitoring machine health using multiple sensors.

### BACKGROUND

Machines can be used to perform various processes. For example, industrial plants that process chemicals can include machines, such as heaters, furnaces, and fired heaters, that perform various steps to process the chemicals. Various characteristics of the machines can be monitored using sensors. This may enable operators of the machines to detect failures of the machines, safety hazards, etc.

### SUMMARY

In one example, a system is provided. The system can include a machine. The system can include a plurality of sensors coupled to the machine for detecting characteristics of the machine. The system can include a processing device communicatively coupled to the plurality of sensors. The system can also include a memory device on which instructions executable by the processing device are stored. The instructions can cause the processing device to receive sensor measurements from the plurality of sensors. The sensor measurements can be usable as data points to form respective time series associated with respective sensors of the plurality of sensors. The instructions can cause the processing device to determine a target sensor to monitor from among the plurality of sensors for detecting an anomaly with the machine. The instructions can cause the processing device to determine magnitude values for a particular component of a time series associated with the target sensor by decomposing the time series into a plurality of components. The instructions can cause the processing device to generate a dataset comprising the magnitude values for the particular component of the time series and the sensor measurements from the plurality of sensors. The instructions can cause the processing device to generate a model using the dataset by assigning respective weights to each respective sensor of the plurality of sensors indicating how the sensor measurements from the respective sensor contribute to the magnitude values for the particular component of the time series associated with the target sensor. The model can be representative of a relationship between (i) the sensor measurements from the plurality of sensors, and (ii) the magnitude values for the particular component of the time series associated with the target sensor. The instructions can cause the processing device to receive additional sensor measurements from a subset of the plurality of sensors that excludes the target sensor. The instructions can cause the processing device to use the model to determine a predicted magnitude value for the particular component of the time series associated with the target sensor based on the additional sensor measurements. The instructions can cause the processing device to identify the anomaly with the machine by determining that (i) the predicted magnitude value of the particular component meets or exceeds a predetermined threshold; or (ii) multiple predicted magnitude values for the particular component comprise a predetermined pattern that is indicative of the anomaly. The instructions can cause the processing device to, based on identifying the anomaly, output a notification indicative of the anomaly.

In another example, a non-transitory computer readable medium comprising program code that is executable by a processing device is provided. The program code can cause the processing device to receive sensor measurements from the plurality of sensors. The sensor measurements can be usable as data points to form respective time series associated with respective sensors of the plurality of sensors. The program code can cause the processing device to determine a target sensor to monitor from among the plurality of sensors for detecting an anomaly with the machine. The program code can cause the processing device to determine magnitude values for a particular component of a time series associated with the target sensor by decomposing the time series into a plurality of components. The program code can cause the processing device to generate a dataset comprising the magnitude values for the particular component of the time series and the sensor measurements from the plurality of sensors. The program code can cause the processing device to generate a model using the dataset by assigning respective weights to each respective sensor of the plurality of sensors indicating how the sensor measurements from the respective sensor contribute to the magnitude values for the particular component of the time series associated with the target sensor. The model can be representative of a relationship between (i) the sensor measurements from the plurality of sensors, and (ii) the magnitude values for the particular component of the time series associated with the target sensor. The program code can cause the processing device to receive additional sensor measurements from a subset of the plurality of sensors that excludes the target sensor. The program code can cause the processing device to use the model to determine a predicted magnitude value for the particular component of the time series associated with the target sensor based on the additional sensor measurements. The program code can cause the processing device to identify the anomaly with the machine by determining that (i) the predicted magnitude value of the particular component meets or exceeds a predetermined threshold; or (ii) multiple predicted magnitude values for the particular component comprise a predetermined pattern that is indicative of the anomaly. The program code can cause the processing device to, based on identifying the anomaly, output a notification indicative of the anomaly.

In another example, a method for performing real-time monitoring of a machine is provided. The method can include receiving sensor measurements from the plurality of sensors. The sensor measurements can be usable as data points to form respective time series associated with respective sensors of the plurality of sensors. The method can include determining a target sensor to monitor from among the plurality of sensors for detecting an anomaly with the machine. The method can include determining magnitude values for a particular component of a time series associated with the target sensor by decomposing the time series into a plurality of components. The method can include generating a dataset comprising the magnitude values for the particular component of the time series and the sensor measurements from the plurality of sensors. The method can include generating a model using the dataset by assigning respective weights to each respective sensor of the plurality of sensors indicating how the sensor measurements from the respective sensor contribute to the magnitude values for the particular component of the time series associated with the target sensor. The model can be representative of a relationship between (i) the sensor measurements from the plurality of sensors, and (ii) the magnitude values for the particular component of the time series associated with the target sensor. The method can include receiving additional sensor measurements from a subset of the plurality of sensors that excludes the target sensor. The method can include using the model to determine a predicted magnitude value for the particular component of the time series associated with the target sensor based on the additional sensor measurements. The method can include identifying the anomaly with the machine by determining that (i) the predicted magnitude value of the particular component meets or exceeds a predetermined threshold; or (ii) multiple predicted magnitude values for the particular component comprise a predetermined pattern that is indicative of the anomaly. The method can include, based on identifying the anomaly, outputting a notification indicative of the anomaly. Some or all of the steps of the method can be performed by a processor.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF THE DRAWINGS

The present disclosure is described in conjunction with the appended figures:

FIG. 1 is a block diagram of an example of the hardware components of a computing system according to some aspects.

FIG. 2 is an example of devices that can communicate with each other over an exchange system and via a network according to some aspects.

FIG. 3 is a block diagram of a model of an example of a communications protocol system according to some aspects.

FIG. 4 is a hierarchical diagram of an example of a communications grid computing system including a variety of control and worker nodes according to some aspects.

FIG. 5 is a flow chart of an example of a process for adjusting a communications grid or a work project in a communications grid after a failure of a node according to some aspects.

FIG. 6 is a block diagram of a portion of a communications grid computing system including a control node and a worker node according to some aspects.

FIG. 7 is a flow chart of an example of a process for executing a data analysis or processing project according to some aspects.

FIG. 8 is a block diagram including components of an Event Stream Processing Engine (ESPE) according to some aspects.

FIG. 9 is a flow chart of an example of a process including operations performed by an event stream processing engine according to some aspects.

FIG. 10 is a block diagram of an ESP system interfacing between a publishing device and multiple event subscribing devices according to some aspects.

FIG. 11 is a block diagram of an example of a system for monitoring the health of a machine using multiple sensors according to some aspects.

FIG. 12 is a flow chart of an example of a process for monitoring machine health using multiple sensors according to some aspects.

FIG. 13 is a table of an example of sensor measurements from a sensor and associated cycle-component values according to some aspects.

FIG. 14 is a table of an example of sensor measurements from multiple sensors and cycle-component values according to some aspects.

FIG. 15 is a flow chart of an example of a process for generating a dataset according to some aspects.

FIG. 16 is a flow chart of an example of a process for generating a model according to some aspects.

FIG. 17 is a graph of an example of cycle-component values and predicted cycle-component values over time according to some aspects.

FIG. 18 is a graph of an example of sensor measurements from a sensor according to some aspects.

FIG. 19 is a graph of an example of cycle components associated with the sensor measurements of FIG. 18 according to some aspects.

FIG. 20 is multiple graphs showing various characteristics of a time series formed from sensor measurements according to some aspects.

In the appended figures, similar components or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTN

In the following description, for the purposes of explanation, specific details are set forth in order to provide a thorough understanding of examples of the technology. But various examples can be practiced without these specific details. The figures and description are not intended to be restrictive.

The ensuing description provides examples only, and is not intended to limit the scope, applicability, or configuration of the disclosure. Rather, the ensuing description of the examples provides those skilled in the art with an enabling description for implementing an example. Various changes may be made in the function and arrangement of elements without departing from the spirit and scope of the technology as set forth in the appended claims.

Specific details are given in the following description to provide a thorough understanding of the examples. But the examples may be practiced without these specific details. For example, circuits, systems, networks, processes, and other components can be shown as components in block diagram form to prevent obscuring the examples in unnecessary detail. In other examples, well-known circuits, processes, algorithms, structures, and techniques may be shown without unnecessary detail in order to avoid obscuring the examples.

Also, individual examples can be described as a process that is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed, but can have additional operations not included in a figure. A process can correspond to a method, a function, a procedure, a subroutine, a subprogram, etc. When a process corresponds to a function, its termination can correspond to a return of the function to the calling function or the main function.

Systems depicted in some of the figures can be provided in various configurations. In some examples, the systems can be configured as a distributed system where one or more components of the system are distributed across one or more networks in a cloud computing system.

Certain aspects and features of the present disclosure relate to monitoring the health of a machine by analyzing time-series component values that are provided as output from a model based on inputs from one or more sensors coupled to the machine. Examples of the machine can include an electronic device, an electronic system, a mechanical device, a mechanical system, or any other type of physical system or combination of physical systems.

More specifically, in some examples, a computing device can be communicatively coupled to one or more sensors for monitoring the health of the machine. The computing device can receive, as input, a selection of one of the sensors for use as a target sensor. The remaining sensors can be secondary sensors. The computing device can then receive sensor measurements from some or all of the secondary sensors. The computing device can apply the sensor measurements from the secondary sensors to the model to predict a value for a component (e.g., a cycle component, a seasonal component, a trend component, etc.) of a time series associated with the target sensor. The model can represent a relationship between the sensor measurements from the secondary sensors and the component of the time series associated with the target sensor.

After determining the predicted value for the component of the time series associated with the target sensor, the computing device can determine if the machine is experiencing an anomaly. The computing device can determine if the machine is experiencing the anomaly by comparing the predicted value for the component to (i) a preset threshold associated with the anomaly, (ii) a preset value associated with the anomaly, (iii) a preset pattern of values associated with the anomaly, or (iv) any combination of these. If the computing device determines that the machine is experiencing the anomaly, the computing device can output a notification indicating (e.g., to an operator of the machine) that the machine is experiencing the anomaly.

In some examples, analyzing a time-series component associated with the target sensor, as opposed to the actual sensor measurements from the target sensor, can result in earlier identification of potential anomalies. For example, the sensor measurements from the target sensor may only be directly used to detect an anomaly while the anomaly is occurring or after the anomaly has occurred. As a particular example, if the machine unexpectedly shuts down, the sensor measurements from the target sensor may indicate a value of zero while the machine is shutting down or after the machine has shutdown. But only detecting the anomaly once the anomaly is occurring or has occurred can be costly, time consuming, and dangerous for an operator of the machine, because the operator has no forewarning that the anomaly will occur. Conversely, some time-series components may have spikes, dips, patterns, and other characteristics that may indicate an anomaly is going to occur before the anomaly actually occurs. For example, a cycle component of a time series may show a spike, a dip, or both prior to an anomaly occurring. These features can be identified by the computing device and a corresponding notification can be output, thereby enabling the operator to take preventative action before the anomaly occurs.

Further, a time series may need to span a significant amount of time (e.g., several months or years) before components of the time series can be accurately determined. For example, a time series may need to span several months before a cycle component or a seasonal component can be accurately determined for the time series. But some examples of the present disclosure overcome this issue by using the model to predict values for the component of the time series. This can enable the component of the time series to be used for monitoring the health of the machine, regardless of the amount of time-series data that is available.

In some examples, the computing device can generate the model using sensor measurements from the target sensor and the secondary sensors (e.g., all of the sensors). For example, the computing device can generate a dataset that includes multiple sensor measurements taken by the secondary sensors at various times. The computing device can also generate a time series from sensor measurements taken by the target sensor, determine values for a component of the time series, and include the component values in the data set. The computing device can then generate the model, using the dataset, by determining relationships between the sensor measurements from the secondary sensors and the determined component-values. Once the model is generated, the computing device can use the model to predict component values based on new sensor measurements subsequently obtained from the secondary sensors.

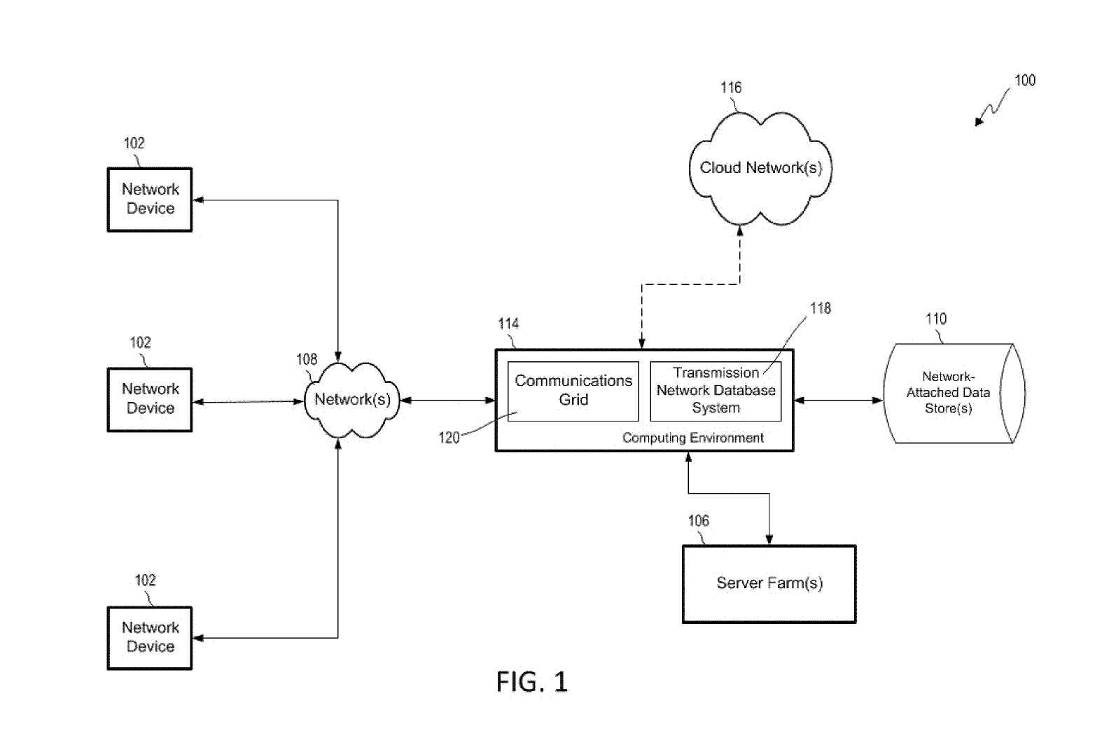

FIGS. 1-10 depict examples of systems and methods usable for monitoring the health of a machine using multiple sensors according to some aspects. For example, FIG. 1 is a block diagram of an example of the hardware components of a computing system according to some aspects. Data transmission network 100 is a specialized computer system that may be used for processing large amounts of data where a large number of computer processing cycles are required.

Data transmission network 100 may also include computing environment 114. Computing environment 114 may be a specialized computer that processes the data received within the data transmission network 100. The computing environment 114 may include one or more other systems. For example, computing environment 114 may include a database system 118 or a communications grid 120. The computing environment 114 can include one or more processors (e.g., distributed over one or more networks or otherwise in communication with one another) that, in some examples, can collectively be referred to as a processor.

Data transmission network 100 also includes one or more network devices 102. Network devices 102 may include client devices that can communicate with computing environment 114. For example, network devices 102 may send data to the computing environment 114 to be processed, may send communications to the computing environment 114 to control different aspects of the computing environment or the data it is processing, among other reasons. Network devices 102 may interact with the computing environment 114 through a number of ways, such as, for example, over one or more networks 108.

In some examples, network devices 102 may provide a large amount of data, either all at once or streaming over a period of time (e.g., using event stream processing (ESP)), to the computing environment 114 via networks 108. For example, the network devices 102 can transmit electronic messages for use in monitoring the health of a machine, all at once or streaming over a period of time, to the computing environment 114 via networks 108.

The network devices 102 may include network computers, sensors, databases, or other devices that may transmit or otherwise provide data to computing environment 114. For example, network devices 102 may include local area network devices, such as routers, hubs, switches, or other computer networking devices. These devices may provide a variety of stored or generated data, such as network data or data specific to the network devices 102 themselves. Network devices 102 may also include sensors that monitor their environment or other devices to collect data regarding that environment or those devices, and such network devices 102 may provide data they collect over time. Network devices 102 may also include devices within the internet of things, such as devices within a home automation network. Some of these devices may be referred to as edge devices, and may involve edge-computing circuitry. Data may be transmitted by network devices 102 directly to computing environment 114 or to network-attached data stores, such as network-attached data stores 110 for storage so that the data may be retrieved later by the computing environment 114 or other portions of data transmission network 100. For example, the network devices 102 can transmit data usable for monitoring the health of a machine to a network-attached data store 110 for storage. The computing environment 114 may later retrieve the data from the network-attached data store 110 and use the data to monitor the health of a machine.

Network-attached data stores 110 can store data to be processed by the computing environment 114 as well as any intermediate or final data generated by the computing system in non-volatile memory. But in certain examples, the configuration of the computing environment 114 allows its operations to be performed such that intermediate and final data results can be stored solely in volatile memory (e.g., RAM), without a requirement that intermediate or final data results be stored to non-volatile types of memory (e.g., disk). This can be useful in certain situations, such as when the computing environment 114 receives ad hoc queries from a user and when responses, which are generated by processing large amounts of data, need to be generated dynamically (e.g., on the fly). In this situation, the computing environment 114 may be configured to retain the processed information within memory so that responses can be generated for the user at different levels of detail as well as allow a user to interactively query against this information.

Network-attached data stores 110 may store a variety of different types of data organized in a variety of different ways and from a variety of different sources. For example, network-attached data stores may include storage other than primary storage located within computing environment 114 that is directly accessible by processors located therein. Network-attached data stores may include secondary, tertiary or auxiliary storage, such as large hard drives, servers, virtual memory, among other types. Storage devices may include portable or non-portable storage devices, optical storage devices, and various other mediums capable of storing, containing data. A computer-readable storage medium or computer-readable storage medium may include a non-transitory medium in which data can be stored and that does not include carrier waves or transitory electronic communications. Examples of a non-transitory medium may include, for example, a magnetic disk or tape, optical storage media such as compact disk or digital versatile disk, flash memory, memory or memory devices. A computer-program product may include code or executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc. may be passed, forwarded, or transmitted via any suitable means including memory sharing, message passing, token passing, network transmission, among others. Furthermore, the data stores may hold a variety of different types of data. For example, network-attached data stores 110 may hold unstructured (e.g., raw) data.

The unstructured data may be presented to the computing environment 114 in different forms such as a flat file or a conglomerate of data records, and may have data values and accompanying time stamps. The computing environment 114 may be used to analyze the unstructured data in a variety of ways to determine the best way to structure (e.g., hierarchically) that data, such that the structured data is tailored to a type of further analysis that a user wishes to perform on the data. For example, after being processed, the unstructured time-stamped data may be aggregated by time (e.g., into daily time period units) to generate time series data or structured hierarchically according to one or more dimensions (e.g., parameters, attributes, or variables). For example, data may be stored in a hierarchical data structure, such as a relational online analytical processing (ROLAP) or multidimensional online analytical processing (MOLAP) database, or may be stored in another tabular form, such as in a flat-hierarchy form.

Data transmission network 100 may also include one or more server farms 106. Computing environment 114 may route select communications or data to the sever farms 106 or one or more servers within the server farms 106. Server farms 106 can be configured to provide information in a predetermined manner. For example, server farms 106 may access data to transmit in response to a communication. Server farms 106 may be separately housed from each other device within data transmission network 100, such as computing environment 114, or may be part of a device or system.

Server farms 106 may host a variety of different types of data processing as part of data transmission network 100. Server farms 106 may receive a variety of different data from network devices, from computing environment 114, from cloud network 116, or from other sources. The data may have been obtained or collected from one or more websites, sensors, as inputs from a control database, or may have been received as inputs from an external system or device. Server farms 106 may assist in processing the data by turning raw data into processed data based on one or more rules implemented by the server farms. For example, sensor data may be analyzed to determine changes in an environment over time or in real-time.

Data transmission network 100 may also include one or more cloud networks 116. Cloud network 116 may include a cloud infrastructure system that provides cloud services. In certain examples, services provided by the cloud network 116 may include a host of services that are made available to users of the cloud infrastructure system on demand. Cloud network 116 is shown in FIG. 1 as being connected to computing environment 114 (and therefore having computing environment 114 as its client or user), but cloud network 116 may be connected to or utilized by any of the devices in FIG. 1. Services provided by the cloud network 116 can dynamically scale to meet the needs of its users. The cloud network 116 may include one or more computers, servers, or systems. In some examples, the computers, servers, or systems that make up the cloud network 116 are different from the user's own on-premises computers, servers, or systems. For example, the cloud network 116 may host an application, and a user may, via a communication network such as the Internet, order and use the application on demand. In some examples, the cloud network 116 may host an application for monitoring the health of a machine.

While each device, server, and system in FIG. 1 is shown as a single device, multiple devices may instead be used. For example, a set of network devices can be used to transmit various communications from a single user, or remote server 140 may include a server stack. As another example, data may be processed as part of computing environment 114.

Each communication within data transmission network 100 (e.g., between client devices, between a device and connection management system 150, between server farms 106 and computing environment 114, or between a server and a device) may occur over one or more networks 108. Networks 108 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or combination of wireless interfaces. As an example, a network in the one or more networks 108 may include a short-range communication channel, such as a Bluetooth or a Bluetooth Low Energy channel. A wired network may include a wired interface. The wired or wireless networks may be implemented using routers, access points, bridges, gateways, or the like, to connect devices in the network 108. The networks 108 can be incorporated entirely within or can include an intranet, an extranet, or a combination thereof. In one example, communications between two or more systems or devices can be achieved by a secure communications protocol, such as secure sockets layer (SSL) or transport layer security (TLS). In addition, data or transactional details may be encrypted.

Some aspects may utilize the Internet of Things (loT), where things (e.g., devices, phones, sensors, etc.) can be connected to networks and the data from these things can be collected and processed within the things or external to the things. For example, the loT can include sensors in many different devices, and high value analytics can be applied to identify hidden relationships and drive increased efficiencies. This can apply to both big data analytics and real-time (e.g., ESP) analytics.

As noted, computing environment 114 may include a communications grid 120 and a transmission network database system 118. Communications grid 120 may be a grid-based computing system for processing large amounts of data. The transmission network database system 118 may be for managing, storing, and retrieving large amounts of data that are distributed to and stored in the one or more network-attached data stores 110 or other data stores that reside at different locations within the transmission network database system 118. The computing nodes in the communications grid 120 and the transmission network database system 118 may share the same processor hardware, such as processors that are located within computing environment 114.

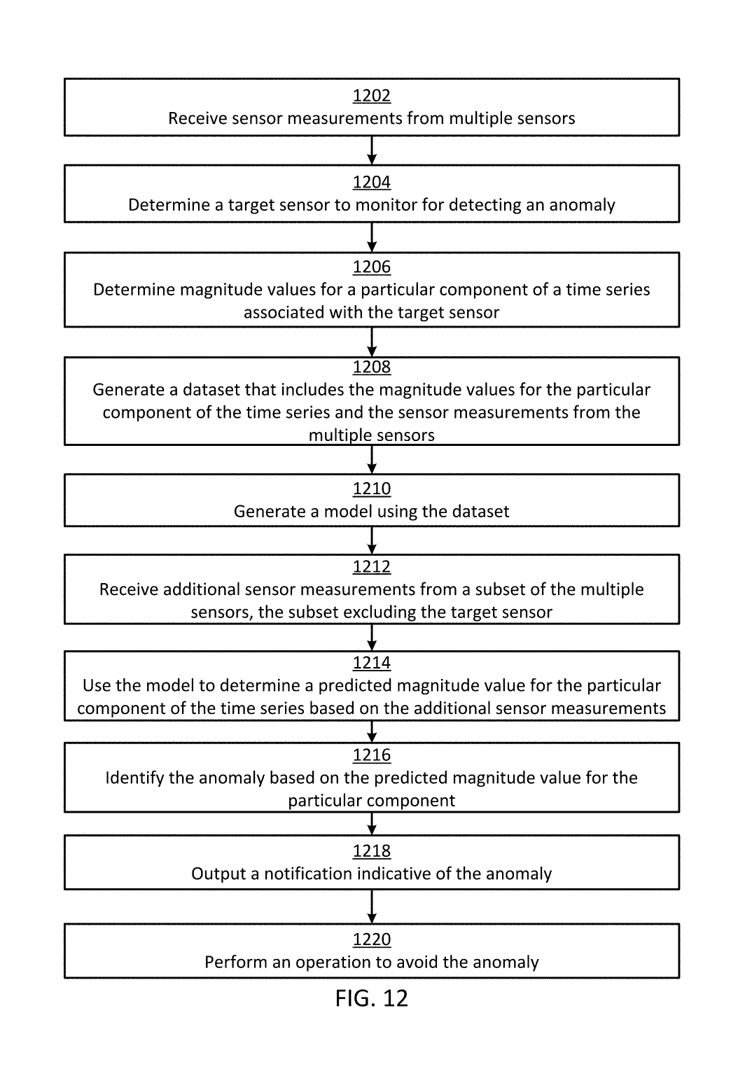

In some examples, the computing environment 114, a network device 102, or both can implement one or more processes for monitoring the health of a machine. For example, the computing environment 114, a network device 102, or both can implement one or more versions of the processes discussed with respect to FIGS. 12-20.

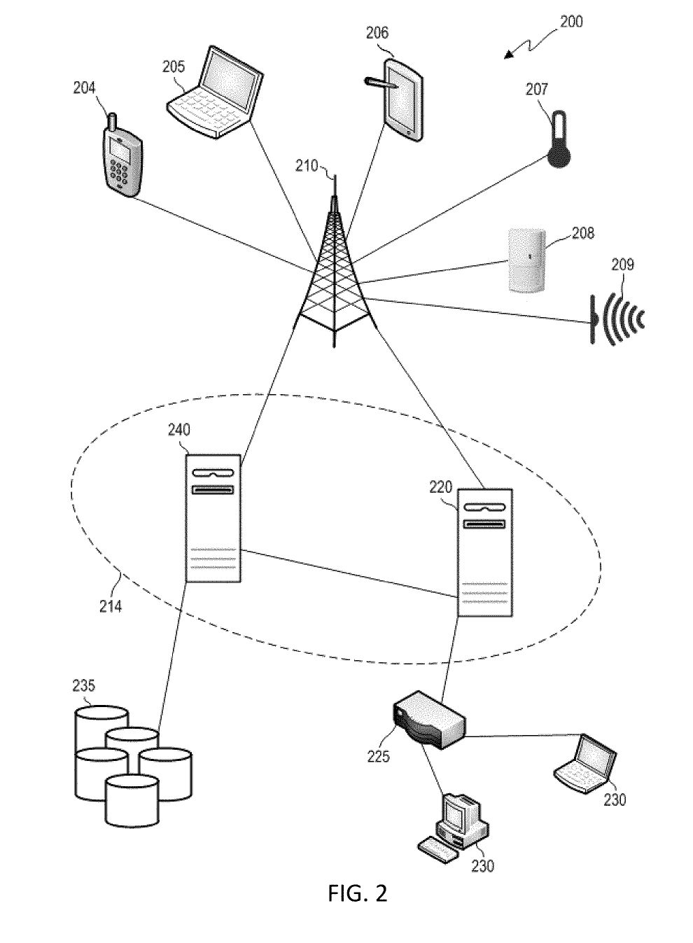

FIG. 2 is an example of devices that can communicate with each other over an exchange system and via a network according to some aspects. As noted, each communication within data transmission network 100 may occur over one or more networks. System 200 includes a network device 204 configured to communicate with a variety of types of client devices, for example client devices 230, over a variety of types of communication channels.

As shown in FIG. 2, network device 204 can transmit a communication over a network (e.g., a cellular network via a base station 210). In some examples, the communication can include times series data. The communication can be routed to another network device, such as network devices 205-209, via base station 210. The communication can also be routed to computing environment 214 via base station 210. In some examples, the network device 204 may collect data either from its surrounding environment or from other network devices (such as network devices 205-209) and transmit that data to computing environment 214.

Although network devices 204-209 are shown in FIG. 2 as a mobile phone, laptop computer, tablet computer, temperature sensor, motion sensor, and audio sensor respectively, the network devices may be or include sensors that are sensitive to detecting aspects of their environment. For example, the network devices may include sensors such as water sensors, power sensors, electrical current sensors, chemical sensors, optical sensors, pressure sensors, geographic or position sensors (e.g., GPS), velocity sensors, acceleration sensors, flow rate sensors, among others. Examples of characteristics that may be sensed include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, and electrical current, among others. The sensors may be mounted to various components used as part of a variety of different types of systems. The network devices may detect and record data related to the environment that it monitors, and transmit that data to computing environment 214.

The network devices 204-209 may also perform processing on data it collects before transmitting the data to the computing environment 214, or before deciding whether to transmit data to the computing environment 214. For example, network devices 204-209 may determine whether data collected meets certain rules, for example by comparing data or values calculated from the data and comparing that data to one or more thresholds. The network devices 204-209 may use this data or comparisons to determine if the data is to be transmitted to the computing environment 214 for further use or processing. In some examples, the network devices 204-209 can pre-process the data prior to transmitting the data to the computing environment 214. For example, the network devices 204-209 can reformat the data before transmitting the data to the computing environment 214 for further processing (e.g., for use in monitoring the health of a machine).

Computing environment 214 may include computing devices 220, 240. Although computing environment 214 is shown in FIG. 2 as having two computing devices 220, 240, computing environment 214 may have only one computing device or may have more than two computing devices. The computing devices 220, 240 that make up computing environment 214 may include specialized computers, servers, or other computing devices that are configured to individually or collectively process large amounts of data. The computing environment 214 may also include storage devices that include one or more databases of structured data, such as data organized in one or more hierarchies, or unstructured data. The databases may communicate with the processing devices within computing environment 214 to distribute data to them. Since network devices may transmit data to computing environment 214, that data may be received by the computing environment 214 and subsequently stored within those storage devices. Data used by computing environment 214 may also be stored in data stores 235, which may also be a part of or connected to computing environment 214.

Computing environment 214 can communicate with various devices via one or more routers 225 or other inter-network or intra-network connection components. For example, computing environment 214 may communicate with client devices 230 via one or more routers 225. Computing environment 214 may collect, analyze or store data from or pertaining to communications, client device operations, client rules, or user-associated actions stored at one or more data stores 235. Such data may influence communication routing to the devices within computing environment 214, how data is stored or processed within computing environment 214, among other actions.

Notably, various other devices can further be used to influence communication routing or processing between devices within computing environment 214 and with devices outside of computing environment 214. For example, as shown in FIG. 2, computing environment 214 may include a computing device 240 that is a web server. Computing environment 214 can retrieve data of interest, such as client information (e.g., product information, client rules, etc.), technical product details, news, blog posts, e-mails, forum posts, electronic documents, social media posts (e.g., Twitter™ posts or Facebook™ posts), time series data, and so on.

In addition to computing environment 214 collecting data (e.g., as received from network devices, such as sensors, and client devices or other sources) to be processed as part of a big data analytics project, it may also receive data in real time as part of a streaming analytics environment. As noted, data may be collected using a variety of sources as communicated via different kinds of networks or locally. Such data may be received on a real-time streaming basis. For example, network devices 204-209 may receive data periodically and in real time from a web server or other source. Devices within computing environment 214 may also perform pre-analysis on data it receives to determine if the data received should be processed as part of an ongoing project. For example, as part of a project in which a machine's health is assessed using data from multiple sensors, the computing environment 214 can perform a pre-analysis of the data. The pre-analysis can include determining whether the data is in a correct format and, if not, reformatting the data into the correct format.

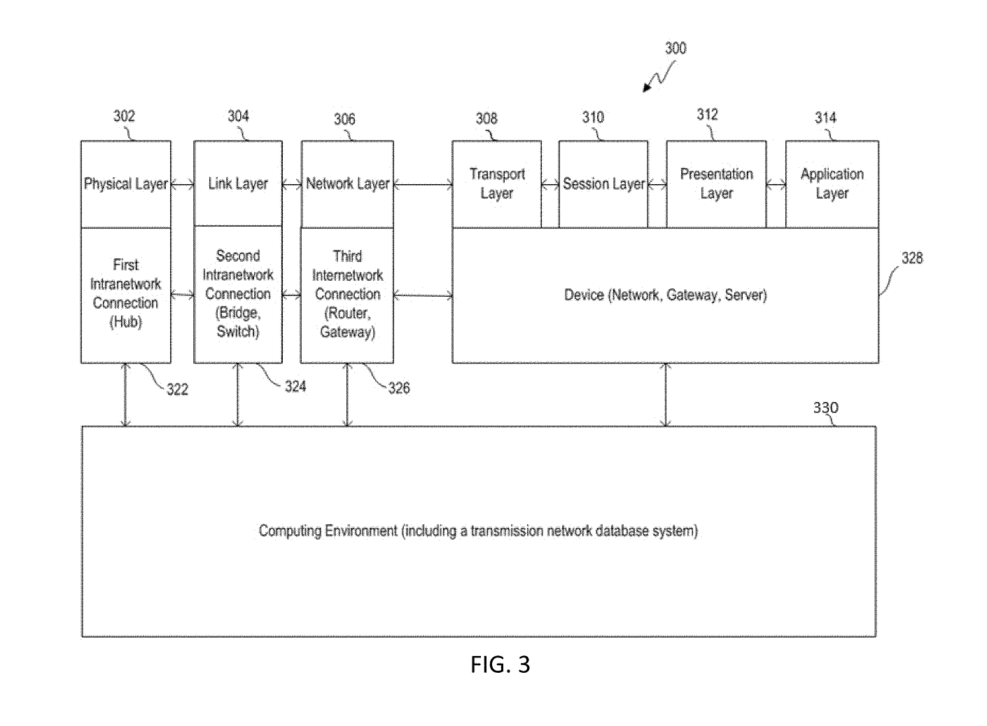

FIG. 3 is a block diagram of a model of an example of a communications protocol system according to some aspects. More specifically, FIG. 3 identifies operation of a computing environment in an Open Systems Interaction model that corresponds to various connection components. The model 300 shows, for example, how a computing environment, such as computing environment (or computing environment 214 in FIG. 2) may communicate with other devices in its network, and control how communications between the computing environment and other devices are executed and under what conditions.

The model 300 can include layers 302-314. The layers 302-314 are arranged in a stack. Each layer in the stack serves the layer one level higher than it (except for the application layer, which is the highest layer), and is served by the layer one level below it (except for the physical layer 302, which is the lowest layer). The physical layer 302 is the lowest layer because it receives and transmits raw bites of data, and is the farthest layer from the user in a communications system. On the other hand, the application layer is the highest layer because it interacts directly with a software application.

As noted, the model 300 includes a physical layer 302. Physical layer 302 represents physical communication, and can define parameters of that physical communication. For example, such physical communication may come in the form of electrical, optical, or electromagnetic communications. Physical layer 302 also defines protocols that may control communications within a data transmission network.

Link layer 304 defines links and mechanisms used to transmit (e.g., move) data across a network. The link layer manages node-to-node communications, such as within a grid-computing environment. Link layer 304 can detect and correct errors (e.g., transmission errors in the physical layer 302). Link layer 304 can also include a media access control (MAC) layer and logical link control (LLC) layer.

Network layer 306 can define the protocol for routing within a network. In other words, the network layer coordinates transferring data across nodes in a same network (e.g., such as a grid-computing environment). Network layer 306 can also define the processes used to structure local addressing within the network.

Transport layer 308 can manage the transmission of data and the quality of the transmission or receipt of that data. Transport layer 308 can provide a protocol for transferring data, such as, for example, a Transmission Control Protocol (TCP). Transport layer 308 can assemble and disassemble data frames for transmission. The transport layer can also detect transmission errors occurring in the layers below it.

Session layer 310 can establish, maintain, and manage communication connections between devices on a network. In other words, the session layer controls the dialogues or nature of communications between network devices on the network. The session layer may also establish checkpointing, adjournment, termination, and restart procedures.

Presentation layer 312 can provide translation for communications between the application and network layers. In other words, this layer may encrypt, decrypt or format data based on data types known to be accepted by an application or network layer.

Application layer 314 interacts directly with software applications and end users, and manages communications between them. Application layer 314 can identify destinations, local resource states or availability or communication content or formatting using the applications.

For example, a communication link can be established between two devices on a network. One device can transmit an analog or digital representation of an electronic message that includes a data set to the other device. The other device can receive the analog or digital representation at the physical layer 302. The other device can transmit the data associated with the electronic message through the remaining layers 304-314. The application layer 314 can receive data associated with the electronic message. The application layer 314 can identify one or more applications, such as an application for monitoring the health of a machine, to which to transmit data associated with the electronic message. The application layer 314 can transmit the data to the identified application.

Intra-network connection components 322, 324 can operate in lower levels, such as physical layer 302 and link layer 304, respectively. For example, a hub can operate in the physical layer, a switch can operate in the physical layer, and a router can operate in the network layer. Inter-network connection components 326, 328 are shown to operate on higher levels, such as layers 306-314. For example, routers can operate in the network layer and network devices can operate in the transport, session, presentation, and application layers.

A computing environment 330 can interact with or operate on, in various examples, one, more, all or any of the various layers. For example, computing environment 330 can interact with a hub (e.g., via the link layer) to adjust which devices the hub communicates with. The physical layer 302 may be served by the link layer 304, so it may implement such data from the link layer 304. For example, the computing environment 330 may control the devices from which it can receive data. For example, if the computing environment 330 knows that a certain network device has turned off, broken, or otherwise become unavailable or unreliable, the computing environment 330 may instruct the hub to prevent any data from being transmitted to the computing environment 330 from that network device. Such a process may be beneficial to avoid receiving data that is inaccurate or that has been influenced by an uncontrolled environment. As another example, computing environment 330 can communicate with a bridge, switch, router or gateway and influence which device within the system (e.g., system 200) the component selects as a destination. In some examples, computing environment 330 can interact with various layers by exchanging communications with equipment operating on a particular layer by routing or modifying existing communications. In another example, such as in a grid-computing environment, a node may determine how data within the environment should be routed (e.g., which node should receive certain data) based on certain parameters or information provided by other layers within the model.

The computing environment 330 may be a part of a communications grid environment, the communications of which may be implemented as shown in the protocol of FIG. 3. For example, referring back to FIG. 2, one or more of computing devices 220 and 240 may be part of a communications grid-computing environment. A gridded computing environment may be employed in a distributed system with non-interactive workloads where data resides in memory on the computing devices, or compute nodes. In such an environment, analytic code, instead of a database management system, can control the processing performed by the nodes. Data is co-located by pre-distributing it to the grid nodes, and the analytic code on each node loads the local data into memory. Each node may be assigned a particular task, such as a portion of a processing project, or to organize or control other nodes within the grid. For example, each node may be assigned a portion of a processing task for monitoring the health of a machine.

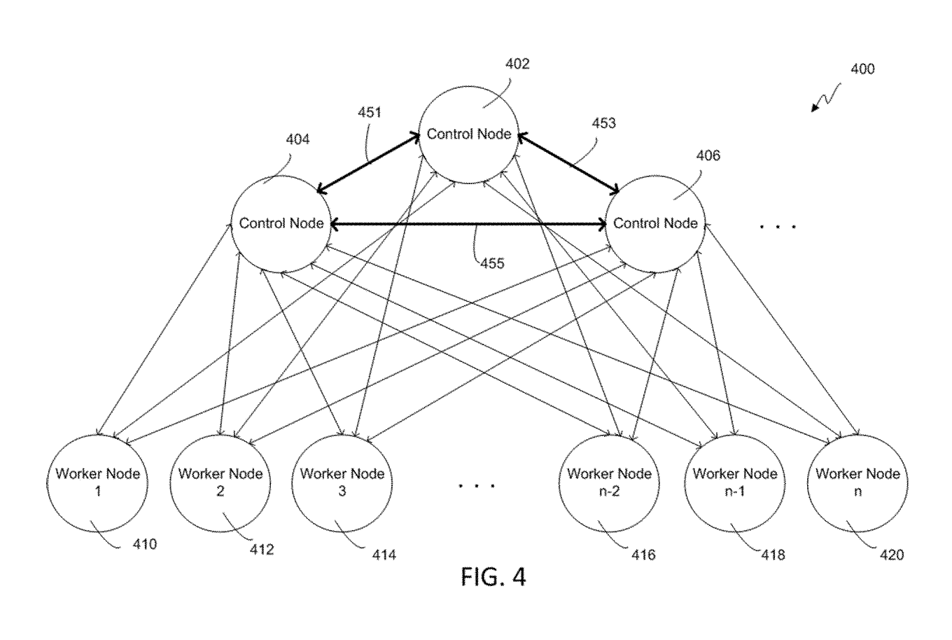

FIG. 4 is a hierarchical diagram of an example of a communications grid computing system 400 including a variety of control and worker nodes according to some aspects. Communications grid computing system 400 includes three control nodes and one or more worker nodes. Communications grid computing system 400 includes control nodes 402, 404, and 406. The control nodes are communicatively connected via communication paths 451, 453, and 455. The control nodes 402-406 may transmit information (e.g., related to the communications grid or notifications) to and receive information from each other. Although communications grid computing system 400 is shown in FIG. 4 as including three control nodes, the communications grid may include more or less than three control nodes.

Communications grid computing system 400 (which can be referred to as a “communications grid”) also includes one or more worker nodes. Shown in FIG. 4 are six worker nodes 410-420. Although FIG. 4 shows six worker nodes, a communications grid can include more or less than six worker nodes. The number of worker nodes included in a communications grid may be dependent upon how large the project or data set is being processed by the communications grid, the capacity of each worker node, the time designated for the communications grid to complete the project, among others. Each worker node within the communications grid computing system 400 may be connected (wired or wirelessly, and directly or indirectly) to control nodes 402-406. Each worker node may receive information from the control nodes (e.g., an instruction to perform work on a project) and may transmit information to the control nodes (e.g., a result from work performed on a project). Furthermore, worker nodes may communicate with each other directly or indirectly. For example, worker nodes may transmit data between each other related to a job being performed or an individual task within a job being performed by that worker node. In some examples, worker nodes may not be connected (communicatively or otherwise) to certain other worker nodes. For example, a worker node 410 may only be able to communicate with a particular control node 402. The worker node 410 may be unable to communicate with other worker nodes 412-420 in the communications grid, even if the other worker nodes 412-420 are controlled by the same control node 402.

A control node 402-406 may connect with an external device with which the control node 402-406 may communicate (e.g., a communications grid user, such as a server or computer, may connect to a controller of the grid). For example, a server or computer may connect to control nodes 402-406 and may transmit a project or job to the node, such as a project or job related to monitoring the health of a machine. The project may include the data set. The data set may be of any size and can include a time series. Once the control node 402-406 receives such a project including a large data set, the control node may distribute the data set or projects related to the data set to be performed by worker nodes. Alternatively, for a project including a large data set, the data set may be receive or stored by a computing device other than a control node 402-406 (e.g., a Hadoop data node).

Control nodes 402-406 can maintain knowledge of the status of the nodes in the grid (e.g., grid status information), accept work requests from clients, subdivide the work across worker nodes, and coordinate the worker nodes, among other responsibilities. Worker nodes 412-420 may accept work requests from a control node 402-406 and provide the control node with results of the work performed by the worker node. A grid may be started from a single node (e.g., a computer, server, etc.). This first node may be assigned or may start as the primary control node 402 that will control any additional nodes that enter the grid.

When a project is submitted for execution (e.g., by a client or a controller of the grid) it may be assigned to a set of nodes. After the nodes are assigned to a project, a data structure (e.g., a communicator) may be created. The communicator may be used by the project for information to be shared between the project code running on each node. A communication handle may be created on each node. A handle, for example, is a reference to the communicator that is valid within a single process on a single node, and the handle may be used when requesting communications between nodes.

A control node, such as control node 402, may be designated as the primary control node. A server, computer or other external device may connect to the primary control node. Once the control node 402 receives a project, the primary control node may distribute portions of the project to its worker nodes for execution. For example, a project for monitoring the health of a machine can be initiated on communications grid computing system 400. A primary control node can control the work to be performed for the project in order to complete the project as requested or instructed. The primary control node may distribute work to the worker nodes 412-420 based on various factors, such as which subsets or portions of projects may be completed most efficiently and in the correct amount of time. For example, a worker node 412 may determine at least some aspect of a machine's health using at least a portion of data that is already local (e.g., stored on) the worker node. The primary control node also coordinates and processes the results of the work performed by each worker node 412-420 after each worker node 412-420 executes and completes its job. For example, the primary control node may receive a result from one or more worker nodes 412-420, and the primary control node may organize (e.g., collect and assemble) the results received and compile them to produce a complete result for the project received from the end user.

Any remaining control nodes, such as control nodes 404, 406, may be assigned as backup control nodes for the project. In an example, backup control nodes may not control any portion of the project. Instead, backup control nodes may serve as a backup for the primary control node and take over as primary control node if the primary control node were to fail. If a communications grid were to include only a single control node 402, and the control node 402 were to fail (e.g., the control node is shut off or breaks) then the communications grid as a whole may fail and any project or job being run on the communications grid may fail and may not complete. While the project may be run again, such a failure may cause a delay (severe delay in some cases, such as overnight delay) in completion of the project. Therefore, a grid with multiple control nodes 402-406, including a backup control node, may be beneficial.

In some examples, the primary control node may open a pair of listening sockets to add another node to the grid. A socket may be used to accept work requests from clients, and the second socket may be used to accept connections from other grid nodes. The primary control node may be provided with a list of other nodes (e.g., other computers, servers, etc.) that can participate in the grid, and the role that each node can fill in the grid. Upon startup of the primary control node (e.g., the first node on the grid), the primary control node may use a network protocol to start the server process on every other node in the grid. Command line parameters, for example, may inform each node of one or more pieces of information, such as: the role that the node will have in the grid, the host name of the primary control node, the port number on which the primary control node is accepting connections from peer nodes, among others. The information may also be provided in a configuration file, transmitted over a secure shell tunnel, recovered from a configuration server, among others. While the other nodes in the grid may not initially know about the configuration of the grid, that information may also be sent to each other node by the primary control node. Updates of the grid information may also be subsequently sent to those nodes.

For any control node other than the primary control node added to the grid, the control node may open three sockets. The first socket may accept work requests from clients, the second socket may accept connections from other grid members, and the third socket may connect (e.g., permanently) to the primary control node. When a control node (e.g., primary control node) receives a connection from another control node, it first checks to see if the peer node is in the list of configured nodes in the grid. If it is not on the list, the control node may clear the connection. If it is on the list, it may then attempt to authenticate the connection. If authentication is successful, the authenticating node may transmit information to its peer, such as the port number on which a node is listening for connections, the host name of the node, information about how to authenticate the node, among other information. When a node, such as the new control node, receives information about another active node, it can check to see if it already has a connection to that other node. If it does not have a connection to that node, it may then establish a connection to that control node.

Any worker node added to the grid may establish a connection to the primary control node and any other control nodes on the grid. After establishing the connection, it may authenticate itself to the grid (e.g., any control nodes, including both primary and backup, or a server or user controlling the grid). After successful authentication, the worker node may accept configuration information from the control node.

When a node joins a communications grid (e.g., when the node is powered on or connected to an existing node on the grid or both), the node is assigned (e.g., by an operating system of the grid) a universally unique identifier (UUID). This unique identifier may help other nodes and external entities (devices, users, etc.) to identify the node and distinguish it from other nodes. When a node is connected to the grid, the node may share its unique identifier with the other nodes in the grid. Since each node may share its unique identifier, each node may know the unique identifier of every other node on the grid. Unique identifiers may also designate a hierarchy of each of the nodes (e.g., backup control nodes) within the grid. For example, the unique identifiers of each of the backup control nodes may be stored in a list of backup control nodes to indicate an order in which the backup control nodes will take over for a failed primary control node to become a new primary control node. But, a hierarchy of nodes may also be determined using methods other than using the unique identifiers of the nodes. For example, the hierarchy may be predetermined, or may be assigned based on other predetermined factors.

The grid may add new nodes at any time (e.g., initiated from any control node). Upon adding a new node to the grid, the control node may first add the new node to its table of grid nodes. The control node may also then notify every other control node about the new node. The nodes receiving the notification may acknowledge that they have updated their configuration information.

Primary control node 402 may, for example, transmit one or more communications to backup control nodes 404, 406 (and, for example, to other control or worker nodes 412-420 within the communications grid). Such communications may be sent periodically, at fixed time intervals, between known fixed stages of the project's execution, among other protocols. The communications transmitted by primary control node 402 may be of varied types and may include a variety of types of information. For example, primary control node 402 may transmit snapshots (e.g., status information) of the communications grid so that backup control node 404 always has a recent snapshot of the communications grid. The snapshot or grid status may include, for example, the structure of the grid (including, for example, the worker nodes 410-420 in the communications grid, unique identifiers of the worker nodes 410-420, or their relationships with the primary control node 402) and the status of a project (including, for example, the status of each worker node's portion of the project). The snapshot may also include analysis or results received from worker nodes 410-420 in the communications grid. The backup control nodes 404, 406 may receive and store the backup data received from the primary control node 402. The backup control nodes 404, 406 may transmit a request for such a snapshot (or other information) from the primary control node 402, or the primary control node 402 may send such information periodically to the backup control nodes 404, 406.

As noted, the backup data may allow a backup control node 404, 406 to take over as primary control node if the primary control node 402 fails without requiring the communications grid to start the project over from scratch. If the primary control node 402 fails, the backup control node 404, 406 that will take over as primary control node may retrieve the most recent version of the snapshot received from the primary control node 402 and use the snapshot to continue the project from the stage of the project indicated by the backup data. This may prevent failure of the project as a whole.

A backup control node 404, 406 may use various methods to determine that the primary control node 402 has failed. In one example of such a method, the primary control node 402 may transmit (e.g., periodically) a communication to the backup control node 404, 406 that indicates that the primary control node 402 is working and has not failed, such as a heartbeat communication. The backup control node 404, 406 may determine that the primary control node 402 has failed if the backup control node has not received a heartbeat communication for a certain predetermined period of time. Alternatively, a backup control node 404, 406 may also receive a communication from the primary control node 402 itself (before it failed) or from a worker node 410-420 that the primary control node 402 has failed, for example because the primary control node 402 has failed to communicate with the worker node 410-420.

Different methods may be performed to determine which backup control node of a set of backup control nodes (e.g., backup control nodes 404, 406) can take over for failed primary control node 402 and become the new primary control node. For example, the new primary control node may be chosen based on a ranking or “hierarchy” of backup control nodes based on their unique identifiers. In an alternative example, a backup control node may be assigned to be the new primary control node by another device in the communications grid or from an external device (e.g., a system infrastructure or an end user, such as a server or computer, controlling the communications grid). In another alternative example, the backup control node that takes over as the new primary control node may be designated based on bandwidth or other statistics about the communications grid.

A worker node within the communications grid may also fail. If a worker node fails, work being performed by the failed worker node may be redistributed amongst the operational worker nodes. In an alternative example, the primary control node may transmit a communication to each of the operable worker nodes still on the communications grid that each of the worker nodes should purposefully fail also. After each of the worker nodes fail, they may each retrieve their most recent saved checkpoint of their status and re-start the project from that checkpoint to minimize lost progress on the project being executed. In some examples, a communications grid computing system 400 can be used to monitor or otherwise assess the health of a machine.

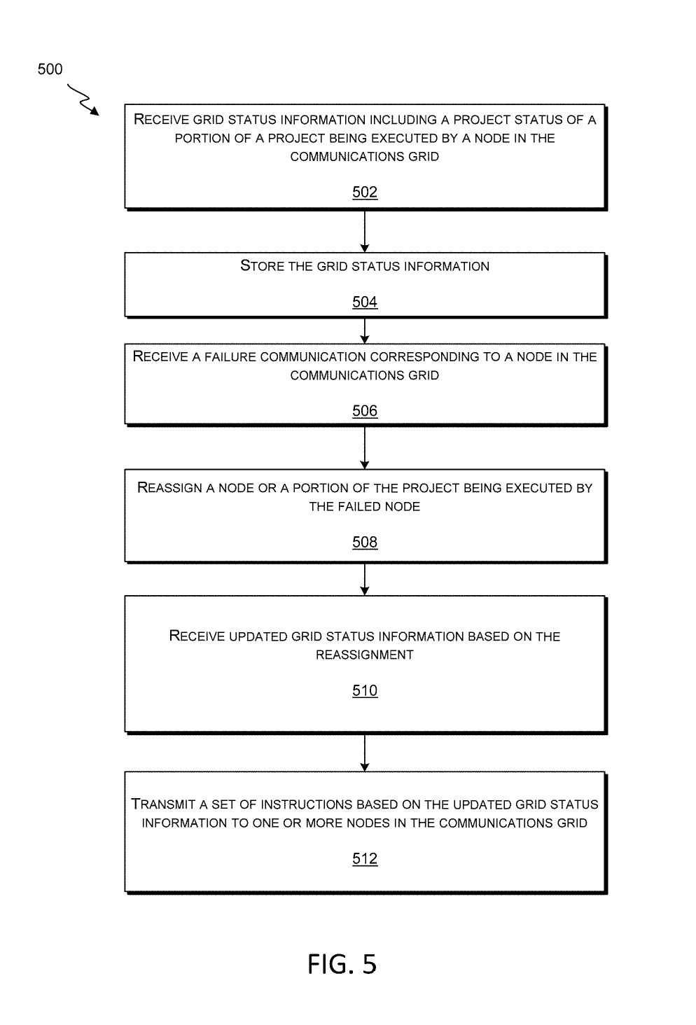

FIG. 5 is a flow chart of an example of a process for adjusting a communications grid or a work project in a communications grid after a failure of a node according to some aspects. The process may include, for example, receiving grid status information including a project status of a portion of a project being executed by a node in the communications grid, as described in operation 502. For example, a control node (e.g., a backup control node connected to a primary control node and a worker node on a communications grid) may receive grid status information, where the grid status information includes a project status of the primary control node or a project status of the worker node. The project status of the primary control node and the project status of the worker node may include a status of one or more portions of a project being executed by the primary and worker nodes in the communications grid. The process may also include storing the grid status information, as described in operation 504. For example, a control node (e.g., a backup control node) may store the received grid status information locally within the control node. Alternatively, the grid status information may be sent to another device for storage where the control node may have access to the information.

The process may also include receiving a failure communication corresponding to a node in the communications grid in operation 506. For example, a node may receive a failure communication including an indication that the primary control node has failed, prompting a backup control node to take over for the primary control node. In an alternative embodiment, a node may receive a failure that a worker node has failed, prompting a control node to reassign the work being performed by the worker node. The process may also include reassigning a node or a portion of the project being executed by the failed node, as described in operation 508. For example, a control node may designate the backup control node as a new primary control node based on the failure communication upon receiving the failure communication. If the failed node is a worker node, a control node may identify a project status of the failed worker node using the snapshot of the communications grid, where the project status of the failed worker node includes a status of a portion of the project being executed by the failed worker node at the failure time.

The process may also include receiving updated grid status information based on the reassignment, as described in operation 510, and transmitting a set of instructions based on the updated grid status information to one or more nodes in the communications grid, as described in operation 512. The updated grid status information may include an updated project status of the primary control node or an updated project status of the worker node. The updated information may be transmitted to the other nodes in the grid to update their stale stored information.

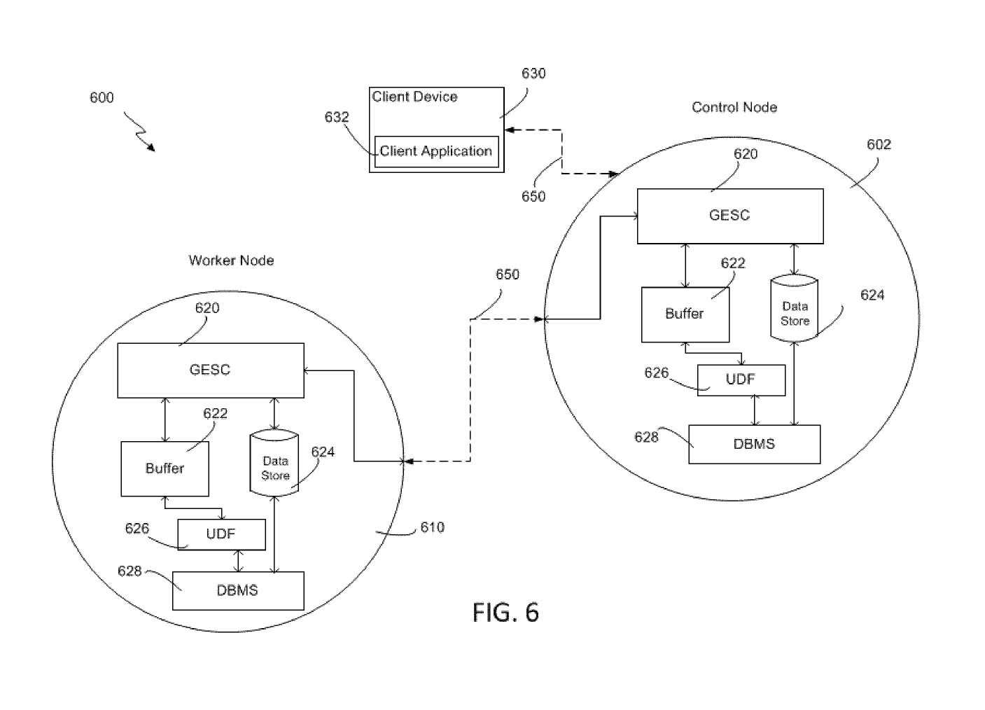

FIG. 6 is a block diagram of a portion of a communications grid computing system 600 including a control node and a worker node according to some aspects. Communications grid 600 computing system includes one control node (control node 602) and one worker node (worker node 610) for purposes of illustration, but may include more worker and/or control nodes. The control node 602 is communicatively connected to worker node 610 via communication path 650. Therefore, control node 602 may transmit information (e.g., related to the communications grid or notifications), to and receive information from worker node 610 via communication path 650.

Similar to in FIG. 4, communications grid computing system (or just “communications grid”) 600 includes data processing nodes (control node 602 and worker node 610). Nodes 602 and 610 comprise multi-core data processors. Each node 602 and 610 includes a grid-enabled software component (GESC) 620 that executes on the data processor associated with that node and interfaces with buffer memory 622 also associated with that node. Each node 602 and 610 includes database management software (DBMS) 628 that executes on a database server (not shown) at control node 602 and on a database server (not shown) at worker node 610.

Each node also includes a data store 624. Data stores 624, similar to network-attached data stores 110 in FIG. 1 and data stores 235 in FIG. 2, are used to store data to be processed by the nodes in the computing environment. Data stores 624 may also store any intermediate or final data generated by the computing system after being processed, for example in non-volatile memory. However in certain examples, the configuration of the grid computing environment allows its operations to be performed such that intermediate and final data results can be stored solely in volatile memory (e.g., RAM), without a requirement that intermediate or final data results be stored to non-volatile types of memory. Storing such data in volatile memory may be useful in certain situations, such as when the grid receives queries (e.g., ad hoc) from a client and when responses, which are generated by processing large amounts of data, need to be generated quickly or on-the-fly. In such a situation, the grid may be configured to retain the data within memory so that responses can be generated at different levels of detail and so that a client may interactively query against this information.

Each node also includes a user-defined function (UDF) 626. The UDF provides a mechanism for the DMBS 628 to transfer data to or receive data from the database stored in the data stores 624 that are managed by the DBMS. For example, UDF 626 can be invoked by the DBMS to provide data to the GESC for processing. The UDF 626 may establish a socket connection (not shown) with the GESC to transfer the data. Alternatively, the UDF 626 can transfer data to the GESC by writing data to shared memory accessible by both the UDF and the GESC.

The GESC 620 at the nodes 602 and 610 may be connected via a network, such as network 108 shown in FIG. 1. Therefore, nodes 602 and 610 can communicate with each other via the network using a predetermined communication protocol such as, for example, the Message Passing Interface (MPI). Each GESC 620 can engage in point-to-point communication with the GESC at another node or in collective communication with multiple GESCs via the network. The GESC 620 at each node may contain identical (or nearly identical) software instructions. Each node may be capable of operating as either a control node or a worker node. The GESC at the control node 602 can communicate, over a communication path 652, with a client device 630. More specifically, control node 602 may communicate with client application 632 hosted by the client device 630 to receive queries and to respond to those queries after processing large amounts of data.

DMBS 628 may control the creation, maintenance, and use of database or data structure (not shown) within nodes 602 or 610. The database may organize data stored in data stores 624. The DMBS 628 at control node 602 may accept requests for data and transfer the appropriate data for the request. With such a process, collections of data may be distributed across multiple physical locations. In this example, each node 602 and 610 stores a portion of the total data managed by the management system in its associated data store 624.

Furthermore, the DBMS may be responsible for protecting against data loss using replication techniques. Replication includes providing a backup copy of data stored on one node on one or more other nodes. Therefore, if one node fails, the data from the failed node can be recovered from a replicated copy residing at another node. However, as described herein with respect to FIG. 4, data or status information for each node in the communications grid may also be shared with each node on the grid.

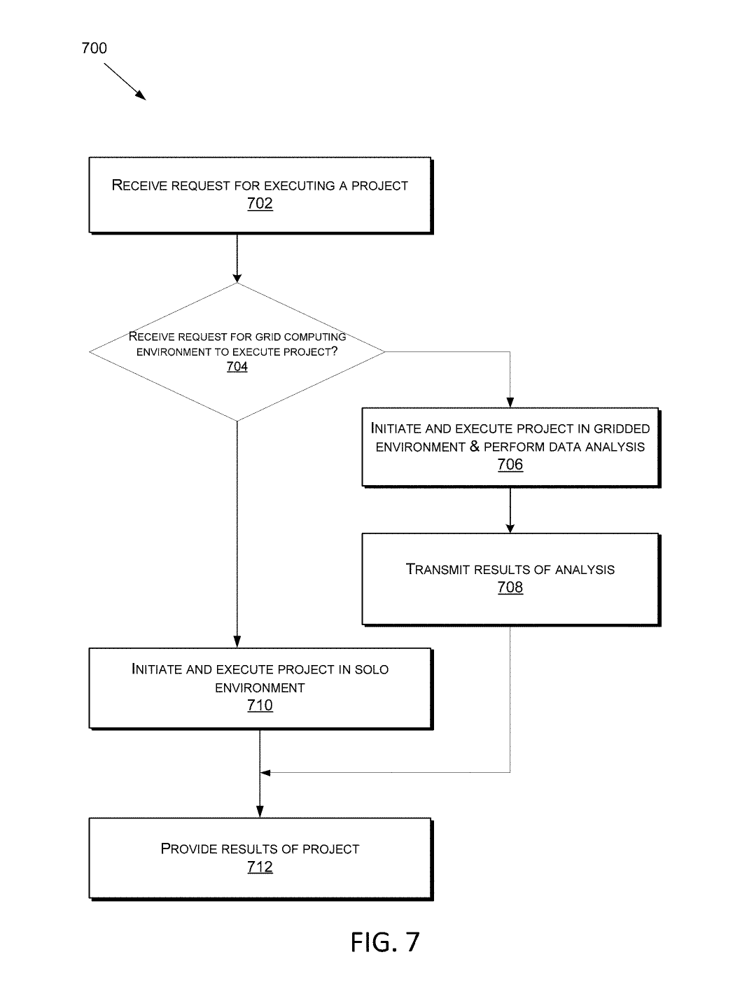

FIG. 7 is a flow chart of an example of a process for executing a data analysis or a processing project according to some aspects. As described with respect to FIG. 6, the GESC at the control node may transmit data with a client device (e.g., client device 630) to receive queries for executing a project and to respond to those queries after large amounts of data have been processed. The query may be transmitted to the control node, where the query may include a request for executing a project, as described in operation 702. The query can contain instructions on the type of data analysis to be performed in the project and whether the project should be executed using the grid-based computing environment, as shown in operation 704.

To initiate the project, the control node may determine if the query requests use of the grid-based computing environment to execute the project. If the determination is no, then the control node initiates execution of the project in a solo environment (e.g., at the control node), as described in operation 710. If the determination is yes, the control node may initiate execution of the project in the grid-based computing environment, as described in operation 706. In such a situation, the request may include a requested configuration of the grid. For example, the request may include a number of control nodes and a number of worker nodes to be used in the grid when executing the project. After the project has been completed, the control node may transmit results of the analysis yielded by the grid, as described in operation 708. Whether the project is executed in a solo or grid-based environment, the control node provides the results of the project.

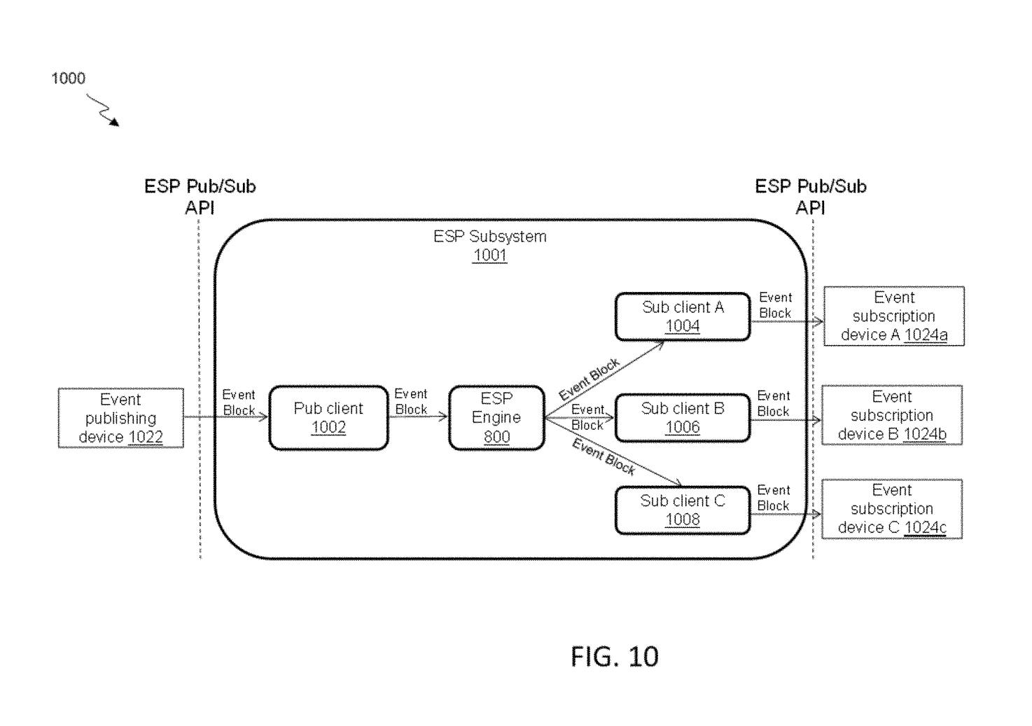

As noted with respect to FIG. 2, the computing environments described herein may collect data (e.g., as received from network devices, such as sensors, such as network devices 204-209 in FIG. 2, and client devices or other sources) to be processed as part of a data analytics project, and data may be received in real time as part of a streaming analytics environment (e.g., ESP). Data may be collected using a variety of sources as communicated via different kinds of networks or locally, such as on a real-time streaming basis. For example, network devices may receive data periodically from network device sensors as the sensors continuously sense, monitor and track changes in their environments. More specifically, an increasing number of distributed applications develop or produce continuously flowing data from distributed sources by applying queries to the data before distributing the data to geographically distributed recipients. An event stream processing engine (ESPE) may continuously apply the queries to the data as it is received and determines which entities should receive the data. Client or other devices may also subscribe to the ESPE or other devices processing ESP data so that they can receive data after processing, based on for example the entities determined by the processing engine. For example, client devices 230 in FIG. 2 may subscribe to the ESPE in computing environment 214. In another example, event subscription devices 1024a-c, described further with respect to FIG. 10, may also subscribe to the ESPE. The ESPE may determine or define how input data or event streams from network devices or other publishers (e.g., network devices 204-209 in FIG. 2) are transformed into meaningful output data to be consumed by subscribers, such as for example client devices 230 in FIG. 2.

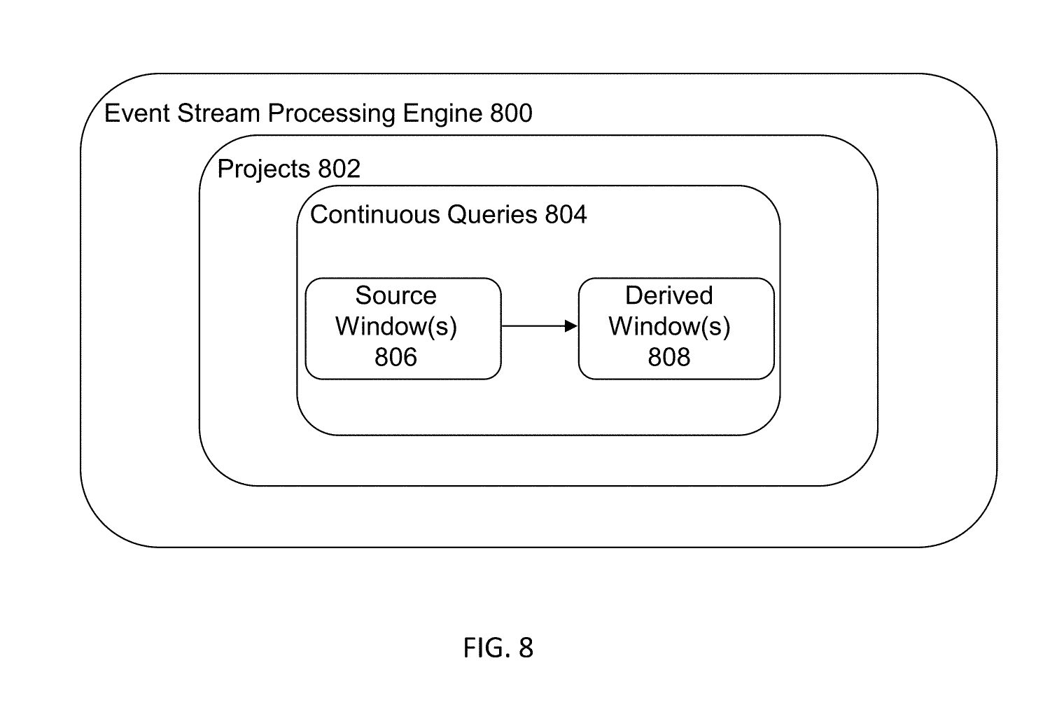

FIG. 8 is a block diagram including components of an Event Stream Processing Engine (ESPE) according to some aspects. ESPE 800 may include one or more projects 802. A project may be described as a second-level container in an engine model managed by ESPE 800 where a thread pool size for the project may be defined by a user. Each project of the one or more projects 802 may include one or more continuous queries 804 that contain data flows, which are data transformations of incoming event streams. The one or more continuous queries 804 may include one or more source windows 806 and one or more derived windows 808.

The ESPE may receive streaming data over a period of time related to certain events, such as events or other data sensed by one or more network devices. The ESPE may perform operations associated with processing data created by the one or more devices. For example, the ESPE may receive data from the one or more network devices 204-209 shown in FIG. 2. As noted, the network devices may include sensors that sense different aspects of their environments, and may collect data over time based on those sensed observations. For example, the ESPE may be implemented within one or more of computing devices 220 and 240 shown in FIG. 2. The ESPE may be implemented within such a computing device by an ESP application. An ESP application may embed an ESPE with its own dedicated thread pool or pools into its application space where the main application thread can do application-specific work and the ESPE processes event streams at least by creating an instance of a model into processing objects.

The engine container is the top-level container in a model that manages the resources of the one or more projects 802. In an illustrative example, there may be only one ESPE 800 for each instance of the ESP application, and ESPE 800 may have a unique engine name. Additionally, the one or more projects 802 may each have unique project names, and each query may have a unique continuous query name and begin with a uniquely named source window of the one or more source windows 806. ESPE 800 may or may not be persistent.

Continuous query modeling involves defining directed graphs of windows for event stream manipulation and transformation. A window in the context of event stream manipulation and transformation is a processing node in an event stream processing model. A window in a continuous query can perform aggregations, computations, pattern-matching, and other operations on data flowing through the window. A continuous query may be described as a directed graph of source, relational, pattern matching, and procedural windows. The one or more source windows 806 and the one or more derived windows 808 represent continuously executing queries that generate updates to a query result set as new event blocks stream through ESPE 800. A directed graph, for example, is a set of nodes connected by edges, where the edges have a direction associated with them.

An event object may be described as a packet of data accessible as a collection of fields, with at least one of the fields defined as a key or unique identifier (ID). The event object may be created using a variety of formats including binary, alphanumeric, XML, etc. Each event object may include one or more fields designated as a primary identifier (ID) for the event so ESPE 800 can support operation codes (opcodes) for events including insert, update, upsert, and delete. Upsert opcodes update the event if the key field already exists; otherwise, the event is inserted. For illustration, an event object may be a packed binary representation of a set of field values and include both metadata and field data associated with an event. The metadata may include an opcode indicating if the event represents an insert, update, delete, or upsert, a set of flags indicating if the event is a normal, partial-update, or a retention generated event from retention policy management, and a set of microsecond timestamps that can be used for latency measurements.

An event block object may be described as a grouping or package of event objects. An event stream may be described as a flow of event block objects. A continuous query of the one or more continuous queries 804 transforms a source event stream made up of streaming event block objects published into ESPE 800 into one or more output event streams using the one or more source windows 806 and the one or more derived windows 808. A continuous query can also be thought of as data flow modeling.

The one or more source windows 806 are at the top of the directed graph and have no windows feeding into them. Event streams are published into the one or more source windows 806, and from there, the event streams may be directed to the next set of connected windows as defined by the directed graph. The one or more derived windows 808 are all instantiated windows that are not source windows and that have other windows streaming events into them. The one or more derived windows 808 may perform computations or transformations on the incoming event streams. The one or more derived windows 808 transform event streams based on the window type (that is operators such as join, filter, compute, aggregate, copy, pattern match, procedural, union, etc.) and window settings. As event streams are published into ESPE 800, they are continuously queried, and the resulting sets of derived windows in these queries are continuously updated.

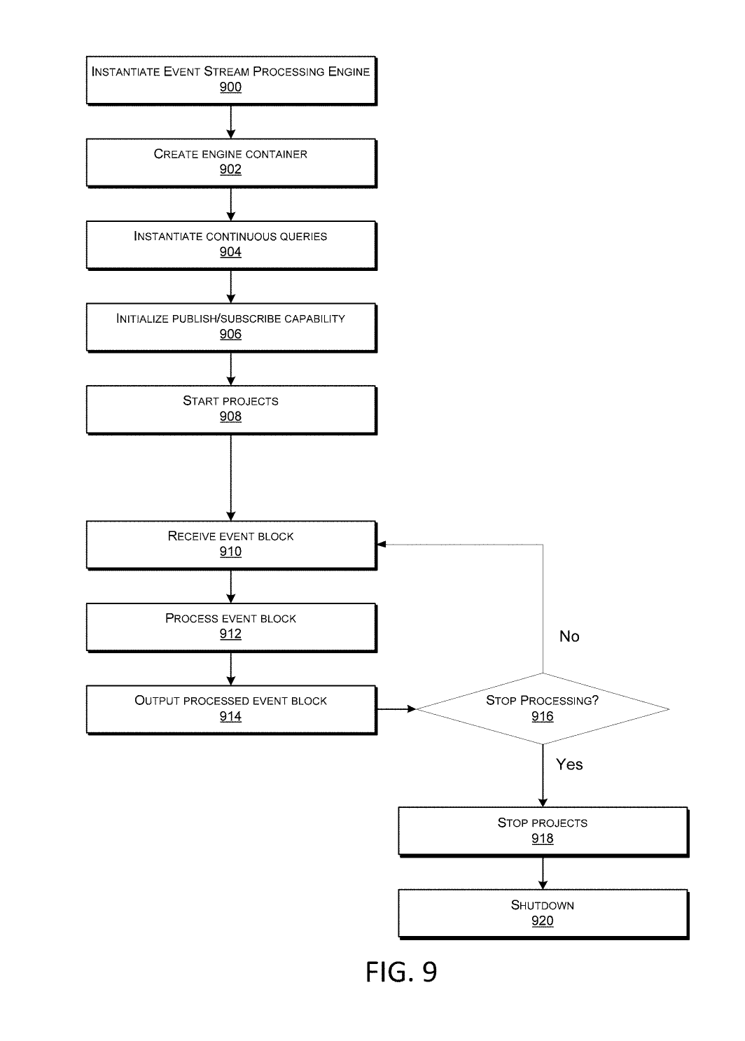

FIG. 9 is a flow chart of an example of a process including operations performed by an event stream processing engine according to some aspects. As noted, the ESPE 800 (or an associated ESP application) defines how input event streams are transformed into meaningful output event streams. More specifically, the ESP application may define how input event streams from publishers (e.g., network devices providing sensed data) are transformed into meaningful output event streams consumed by subscribers (e.g., a data analytics project being executed by a computing device or set of computing devices).

Within the application, a user may interact with one or more user interface windows presented to the user in a display under control of the ESPE independently or through a browser application in an order selectable by the user. For example, a user may execute an ESP application, which causes presentation of a first user interface window, which may include a plurality of menus and selectors such as drop down menus, buttons, text boxes, hyperlinks, etc. associated with the ESP application as understood by a person of skill in the art. Various operations may be performed in parallel, for example, using a plurality of threads.

At operation 900, an ESP application may define and start an ESPE, thereby instantiating an ESPE at a device, such as computing device 220 and/or 240. In an operation 902, the engine container is created. For illustration, ESPE 800 may be instantiated using a function call that specifies the engine container as a manager for the model.

In an operation 904, the one or more continuous queries 804 are instantiated by ESPE 800 as a model. The one or more continuous queries 804 may be instantiated with a dedicated thread pool or pools that generate updates as new events stream through ESPE 800. For illustration, the one or more continuous queries 804 may be created to model business processing logic within ESPE 800, to predict events within ESPE 800, to model a physical system within ESPE 800, to predict the physical system state within ESPE 800, etc. For example, as noted, ESPE 800 may be used to support sensor data monitoring and management (e.g., sensing may include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, or electrical current, etc.).

ESPE 800 may analyze and process events in motion or “event streams.” Instead of storing data and running queries against the stored data, ESPE 800 may store queries and stream data through them to allow continuous analysis of data as it is received. The one or more source windows 806 and the one or more derived windows 808 may be created based on the relational, pattern matching, and procedural algorithms that transform the input event streams into the output event streams to model, simulate, score, test, predict, etc. based on the continuous query model defined and application to the streamed data.

In an operation 906, a publish/subscribe (pub/sub) capability is initialized for ESPE 800. In an illustrative embodiment, a pub/sub capability is initialized for each project of the one or more projects 802. To initialize and enable pub/sub capability for ESPE 800, a port number may be provided. Pub/sub clients can use a host name of an ESP device running the ESPE and the port number to establish pub/sub connections to ESPE 800.

FIG. 10 is a block diagram of an ESP system 1000 interfacing between publishing device 1022 and event subscribing devices 1024a-c according to some aspects. ESP system 1000 may include ESP device or subsystem 1001, publishing device 1022, an event subscribing device A 1024a, an event subscribing device B 1024b, and an event subscribing device C 1024c. Input event streams are output to ESP device 1001 by publishing device 1022. In alternative embodiments, the input event streams may be created by a plurality of publishing devices. The plurality of publishing devices further may publish event streams to other ESP devices. The one or more continuous queries instantiated by ESPE 800 may analyze and process the input event streams to form output event streams output to event subscribing device A 1024a, event subscribing device B 1024b, and event subscribing device C 1024c. ESP system 1000 may include a greater or a fewer number of event subscribing devices of event subscribing devices.

Publish-subscribe is a message-oriented interaction paradigm based on indirect addressing. Processed data recipients specify their interest in receiving information from ESPE 800 by subscribing to specific classes of events, while information sources publish events to ESPE 800 without directly addressing the receiving parties. ESPE 800 coordinates the interactions and processes the data. In some cases, the data source receives confirmation that the published information has been received by a data recipient.

A publish/subscribe API may be described as a library that enables an event publisher, such as publishing device 1022, to publish event streams into ESPE 800 or an event subscriber, such as event subscribing device A 1024a, event subscribing device B 1024b, and event subscribing device C 1024c, to subscribe to event streams from ESPE 800. For illustration, one or more publish/subscribe APIs may be defined. Using the publish/subscribe API, an event publishing application may publish event streams into a running event stream processor project source window of ESPE 800, and the event subscription application may subscribe to an event stream processor project source window of ESPE 800.

The publish/subscribe API provides cross-platform connectivity and endianness compatibility between ESP application and other networked applications, such as event publishing applications instantiated at publishing device 1022, and event subscription applications instantiated at one or more of event subscribing device A 1024a, event subscribing device B 1024b, and event subscribing device C 1024c.

Referring back to FIG. 9, operation 906 initializes the publish/subscribe capability of ESPE 800. In an operation 908, the one or more projects 802 are started. The one or more started projects may run in the background on an ESP device. In an operation 910, an event block object is received from one or more computing device of the publishing device 1022.

ESP subsystem 800 may include a publishing client 1002, ESPE 800, a subscribing client A 1004, a subscribing client B 1006, and a subscribing client C 1008. Publishing client 1002 may be started by an event publishing application executing at publishing device 1022 using the publish/subscribe API. Subscribing client A 1004 may be started by an event subscription application A, executing at event subscribing device A 1024a using the publish/subscribe API. Subscribing client B 1006 may be started by an event subscription application B executing at event subscribing device B 1024b using the publish/subscribe API. Subscribing client C 1008 may be started by an event subscription application C executing at event subscribing device C 1024c using the publish/subscribe API.

An event block object containing one or more event objects is injected into a source window of the one or more source windows 806 from an instance of an event publishing application on publishing device 1022. The event block object may be generated, for example, by the event publishing application and may be received by publishing client 1002. A unique ID may be maintained as the event block object is passed between the one or more source windows 806 and/or the one or more derived windows 808 of ESPE 800, and to subscribing client A 1004, subscribing client B 806, and subscribing client C 808 and to event subscription device A 1024a, event subscription device B 1024b, and event subscription device C 1024c. Publishing client 1002 may further generate and include a unique embedded transaction ID in the event block object as the event block object is processed by a continuous query, as well as the unique ID that publishing device 1022 assigned to the event block object.

In an operation 912, the event block object is processed through the one or more continuous queries 804. In an operation 914, the processed event block object is output to one or more computing devices of the event subscribing devices 1024a-c. For example, subscribing client A 804, subscribing client B 806, and subscribing client C 808 may send the received event block object to event subscription device A 1024a, event subscription device B 1024b, and event subscription device C 1024c, respectively.

ESPE 800 maintains the event block containership aspect of the received event blocks from when the event block is published into a source window and works its way through the directed graph defined by the one or more continuous queries 804 with the various event translations before being output to subscribers. Subscribers can correlate a group of subscribed events back to a group of published events by comparing the unique ID of the event block object that a publisher, such as publishing device 1022, attached to the event block object with the event block ID received by the subscriber.

In an operation 916, a determination is made concerning whether or not processing is stopped. If processing is not stopped, processing continues in operation 910 to continue receiving the one or more event streams containing event block objects from the, for example, one or more network devices. If processing is stopped, processing continues in an operation 918. In operation 918, the started projects are stopped. In operation 920, the ESPE is shutdown.

As noted, in some examples, big data is processed for an analytics project after the data is received and stored. In other examples, distributed applications process continuously flowing data in real-time from distributed sources by applying queries to the data before distributing the data to geographically distributed recipients. As noted, an event stream processing engine (ESPE) may continuously apply the queries to the data as it is received and determines which entities receive the processed data. This allows for large amounts of data being received and/or collected in a variety of environments to be processed and distributed in real time. For example, as shown with respect to FIG. 2, data may be collected from network devices that may include devices within the internet of things, such as devices within a home automation network. However, such data may be collected from a variety of different resources in a variety of different environments. In any such situation, embodiments of the present technology allow for real-time processing of such data.

Aspects of the present disclosure provide technical solutions to technical problems, such as computing problems that arise when an ESP device fails which results in a complete service interruption and potentially significant data loss. The data loss can be catastrophic when the streamed data is supporting mission critical operations, such as those in support of an ongoing manufacturing or drilling operation. An example of an ESP system achieves a rapid and seamless failover of ESPE running at the plurality of ESP devices without service interruption or data loss, thus significantly improving the reliability of an operational system that relies on the live or real-time processing of the data streams. The event publishing systems, the event subscribing systems, and each ESPE not executing at a failed ESP device are not aware of or effected by the failed ESP device. The ESP system may include thousands of event publishing systems and event subscribing systems. The ESP system keeps the failover logic and awareness within the boundaries of out-messaging network connector and out-messaging network device.

In one example embodiment, a system is provided to support a failover when event stream processing (ESP) event blocks. The system includes, but is not limited to, an out-messaging network device and a computing device. The computing device includes, but is not limited to, one or more processors and one or more computer-readable mediums operably coupled to the one or more processor. The processor is configured to execute an ESP engine (ESPE). The computer-readable medium has instructions stored thereon that, when executed by the processor, cause the computing device to support the failover. An event block object is received from the ESPE that includes a unique identifier. A first status of the computing device as active or standby is determined. When the first status is active, a second status of the computing device as newly active or not newly active is determined. Newly active is determined when the computing device is switched from a standby status to an active status. When the second status is newly active, a last published event block object identifier that uniquely identifies a last published event block object is determined. A next event block object is selected from a non-transitory computer-readable medium accessible by the computing device. The next event block object has an event block object identifier that is greater than the determined last published event block object identifier. The selected next event block object is published to an out-messaging network device. When the second status of the computing device is not newly active, the received event block object is published to the out-messaging network device. When the first status of the computing device is standby, the received event block object is stored in the non-transitory computer-readable medium.

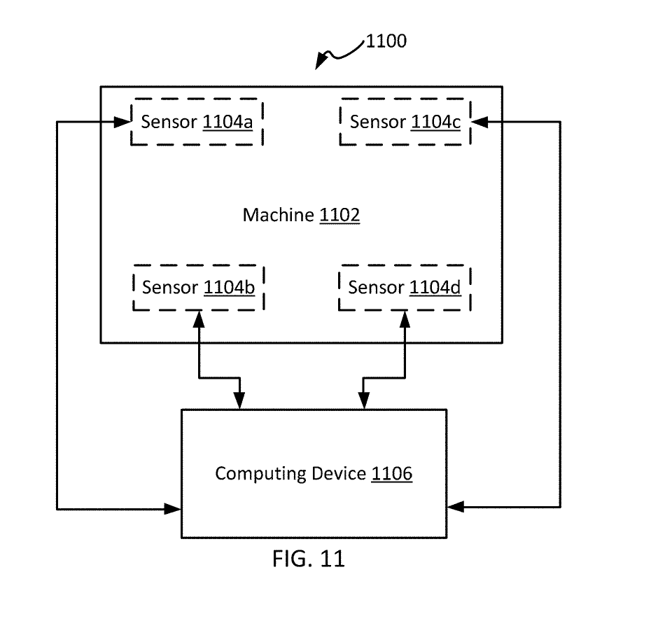

FIG. 11 is a block diagram of an example of a system 1100 for monitoring the health of a machine 1102 using multiple sensors 1104a-d according to some aspects. The machine 1102 can include an electronic device, an electronic system, a mechanical device, a mechanical system, or any other type of physical system or combination of physical systems. For example, the machine 1102 can be a furnace; a pump; a heater; or a computing device, such as a laptop computer, desktop computer, server, mobile phone, etc. In some examples, the machine 1102 can include one or more subsystems. For example, the machine 1102 can be a furnace formed from multiple subsystems, such as a heating unit, a computing device, a conveyor belt, a fluid pump, a valve, etc.

The system 1100 also includes one or more sensors 1104a-d. In some examples, the sensors 1104a-d can be included within or coupled to the machine 1102. The sensors 1104a-d can be positioned to detect characteristics of the machine 1102, ambient conditions (e.g., near to the machine 1102), or both of these. In an example in which the machine 1102 is a furnace, the sensors 1104a-d can detect a firing rate of the furnace, a feed rate of a material into or through the furnace, a temperature in a bridge-wall section of the furnace, a temperature in a stack section of the furnace, an atmospheric temperature, a humidity, a wind direction, or any combination of these. For example, sensor 1104a can detect the feed rate of the material into or through the furnace, sensor 1104b can detect the temperature in the bridge-wall section of the furnace, sensor 1104c can detect the temperature in the stack section of the furnace, and sensor 1104d can detect the atmospheric temperature. The sensors 1104a-d can transmit sensor signals indicating the sensed measurements to a computing device 1106.

The computing device 1106 can receive the sensor signals from the sensors 1104a-d and perform one or more tasks based on the sensor signals. For example, the computing device 1106 can receive the sensor signals and determine the health of the machine 1102 based on the sensor signals. The health of a machine can refer to an operational state of the machine, such as whether the machine is operating correctly (operating as intended according to one or more predetermined specifications) or incorrectly; whether the machine has failed, restarted, or shutdown; whether the machine is going to fail or is likely to fail; or any combination of these. In some examples, the computing device 1106 can monitor or determine the health of the machine 1102 by performing some or all of the operations shown in FIG. 12.

FIG. 12 is a flow chart of an example of a process for monitoring machine health using multiple sensors according to some aspects. Some examples can include more, fewer, or different operations than the operations depicted in FIG. 12. Also, some examples can implement the operations of the process in a different order. Some examples can be implemented using any of the systems and processes described with respect to FIGS. 1-11.

In block 1202, a processor receives sensor measurements from multiple sensors. The sensors can be for monitoring or assessing the health of a machine. The sensors can take sensor measurements at predetermined intervals and transmit sensor signals indicative of the sensor measurements to the processor via a wired or wireless interface. The processor can receive the sensor signals via the wired or wireless interface and store the sensor measurements in memory.

In some examples, the processor can also store timestamps associated with the sensor measurements in memory. For example, the processor can receive a timestamp from a sensor along with a sensor measurement. The timestamp can indicate when a sensor measurement was taken. As another example, the processor can generate a timestamp upon receiving the sensor measurement from the sensor. The processor can store the timestamp with the sensor measurement in memory.

In some examples, the processor can form a time series using the sensor measurements from a particular sensor. For example, the processor can receive, from a particular sensor, sensor measurements at regular intervals over a time period. Each sensor measurement can be used as a data point in a time series that spans the time period. For example, the processor can include each sensor measurements as a data point in a time series that spans the time period and is associated with the particular sensor. The processor can repeat this process to form respective time series for the multiple sensors.

In some examples, the time series can be a count series. A count series can be a time series for which the data points have discrete values (e.g., 0, 1, 2, 3, and the like). In other examples, the time series can be an intermittent time-series. An intermittent time series can include data points that are mostly zero, with occasional departures from zero. The processor can form any number and combination of time series associated with respective sensors.

In some examples, the processor can receive the sensor measurements from the multiple sensors via a remote computing device or another intermediary. For example, the processor can query the remote computing device for the sensor measurements. In response to the query, the remote computing device can obtain the sensor measurements (e.g., directly from the sensors, or indirectly, such as from yet another computing device) and communicate the sensor measurements to the processor.

In block 1204, the processor determines a target sensor to monitor for detecting an anomaly with the machine. The processor determines the target sensor from among the multiple sensors discussed in block 1202. The remainder of the sensors (exclusive of the target sensor) can be referred to as secondary sensors. In some examples, the processor can receive user input (e.g., via a touchscreen, keyboard, or mouse) indicating which of the multiple sensors is to be the target sensor. For example, the processor can receive user input indicating that the target sensor is to be a sensor that detects the firing rate of the machine.

In other examples, an indication of the target sensor can be preprogrammed into memory. For example, a manufacturer, distributor, or installer of the machine can preprogram into memory which of the multiple sensors is to be used as the target sensor. The processor can access memory to identify which of the multiple sensors is to be used as the target sensor.

The processor can determine information associated with the sensor measurements from the target sensor and use that information to detect an anomaly with the machine. The anomaly include failure of the machine; a restart of the machine; a shutdown of the machine; a stoppable or notable slowdown of the machine, that a component or multiple components of the machine are operating incorrectly (operating counter to one or more predetermined specifications); or any combination of these.

In block 1206, the processor determines magnitude values for a particular component of a time series associated with the target sensor. For example, the processor can receive a time series formed using sensor measurements from the target sensor. Alternatively, the processor can generate the time series using the sensor measurements from the target sensor. The processor can then decompose the time series into sub-components and determine magnitude values for at least one of the sub-components.

As a particular example, the processor can use time-series decomposition to decompose the time series into a cycle component, a seasonal component, a trend component, an irregular component, or any combination of these. For example, classical time-series decomposition can break down a time series according to the following model:

yₜ=Tₜ+Cₜ+Sₜ+Iₜ

where yₜ is a magnitude of the time series at time t; Tₜ is a trend component at time t, where the trend component reflects a long-term progression of the time series; Cₜ is a cycle (or “cyclical” component) component at time t, where the cycle component describes repeated but non-periodic fluctuations in the time series; Sₜ is a seasonal component at time t, where the seasonal component reflects a fixed seasonality over a known period due to seasonal factors; and Iₜ is an irregular component (or “noise” component) at time t, where the irregular component describes random, irregular influences. The processor can use time-series decomposition to decompose each data point (sensor measurement) in the time series into a respective cycle-component value, a respective seasonal-component value, a respective trend-component value, a respective noise-component value, or any combination of these.

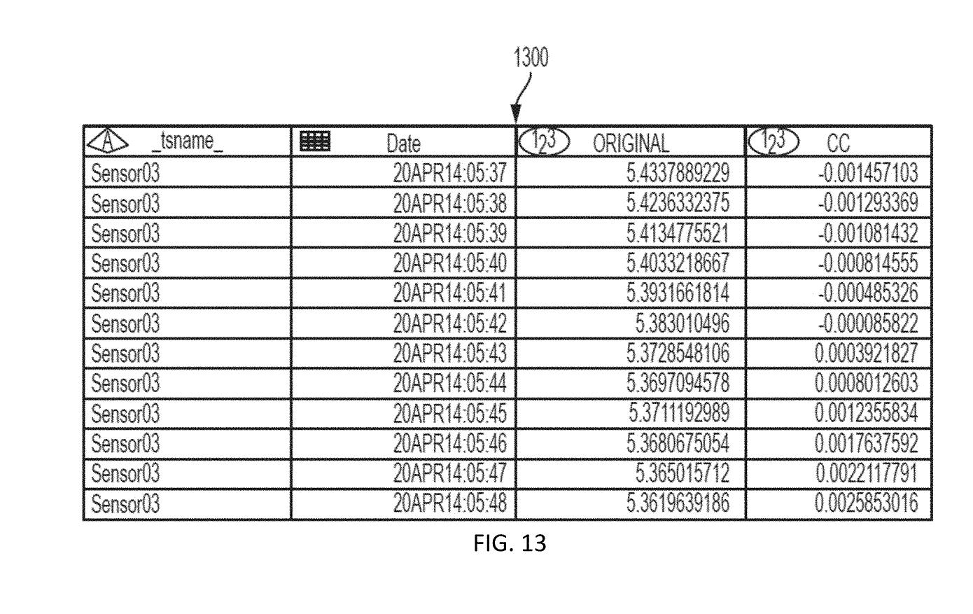

One example of sensor measurements and respective cycle-component values is shown in the table 1300 of FIG. 13. The table 1300 includes multiple sensor measurements (shown in the Original column) obtained from a sensor, Sensor03. The sensor measurements were taken at the various times shown in the Date column. A cycle-component value associated with each respective sensor measurement has also been computed and included in the CC column of table 1300.

In some examples, the processor can use other approaches in addition to or alternatively to classical time-series decomposition to break down the time series into one or more components. For example, the processor can use additive decomposition, multiplicative decomposition, singular spectrum analysis (SSA), an exponential-smoothing model (ESM), an autoregressive integrated moving-average model with or without exogenous variables (ARIMA[X]), an unobserved-components model (UCM), an intermittent-demand model (IDM), or any combination of these to decompose the time series into one or more components (and determine the magnitude values for the one or more components). Some of these models are discussed in greater below.

An ESM can decompose a time series into a level component, a trend component, a seasonal component, an error component, or any combination of these. More specifically, ESMs break down a time series according to the following model:

g(yₜ)=μₜ+βₜ+sₚ(t)+εₜ

where yₜ is a magnitude of the time series at time t; g(yₜ) is a function that transforms yₜ (e.g., applies a logarithm, square root, or other operation to yₜ); μₜis a level component that represents a mean of the time series; βₜis a trend component that represents a slope in the time series; sₚ(t) is a seasonal component that represents a contribution from one of the ρ seasons at time t; and εₜ is an error component. In some examples, the value for μₜ can be smoothed by a weight, the value for βₜ can be smoothed or damped by another weight, the value for sₚ(t) can be smoothed by yet another weight, or any combination of these.

A UCM can decompose a time series into a trend component, a seasonal component, a cycle component, and regression effects. For example, a UCM can break down a time series according to the following model:

g(yₜ)=μₜ+γₜ+φₚ+Σᵢ₌₁^{N}βᵢx_{i,t}+εₜ

where yₜ is a magnitude of the time series at time t; g(yₜ) is a function that transforms yₜ; μₜ is a level component that represents a mean of the time series; γₜ is a seasonal component of the p seasons; (φₚ is a cycle component of the p seasons; βᵢx_{i,t}, is input-series components (e.g., other time series that can be used as independent predictors for estimating yₜ); and εₜ is an error component.

An IDM can decompose an intermittent time-series into either (i) a demand-interval series and a demand-size series; or (ii) an average-demand series. An intermittent time-series can include data points that are mostly zero, which can be referred to as the base value, with occasional departures from the base value. The demand-interval series and the demand-size series can be indexed based on when demand occurred, rather than a time period (e.g., a time index). The demand-interval series can be constructed based on the number of time periods between demands. The demand-size series can be constructed based on the size (or value) of the demands, excluding demands of size zero (i.e., excluding the base-value demands).

The processor can use any number and combination of techniques to decompose a time series into any number and combination of components having any number and combination of magnitude values. For example, the processor can use two or more of the abovementioned techniques on a time series associated with the target sensor to determine magnitude values for two or more components of the time series.

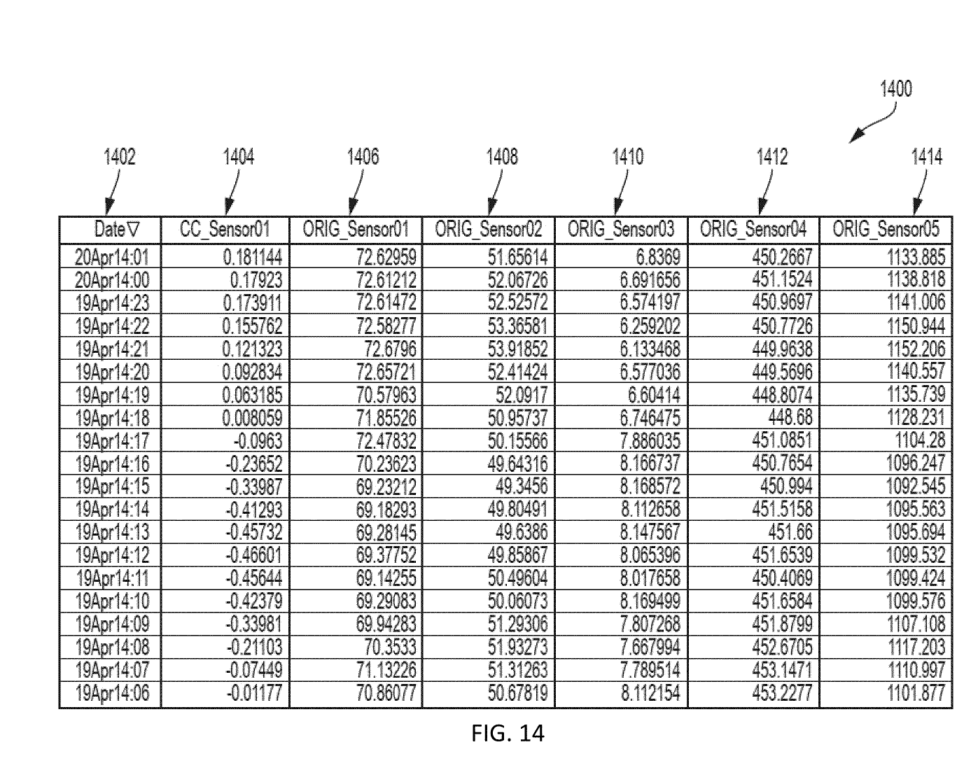

Returning to FIG. 12, in block 1208, the processor generates a dataset that includes the magnitude values for the particular component (or components) of the time series and the sensor measurements from the multiple sensors. For example, the processor can generate a table, such as table 1400 of FIG. 14. The table 1400 can have a date column 1402 indicating when a sensor measurement was taken, a component-value column 1404 indicating a magnitude value of a component (in this example, a cycle component) associated with the sensor measurement, a sensor-measurement column 1406 indicating the sensor measurement for the target sensor (in this case Sensor01), and additional sensor-measurement columns 1408-1414 indicating sensor measurements taken by the secondary sensors.

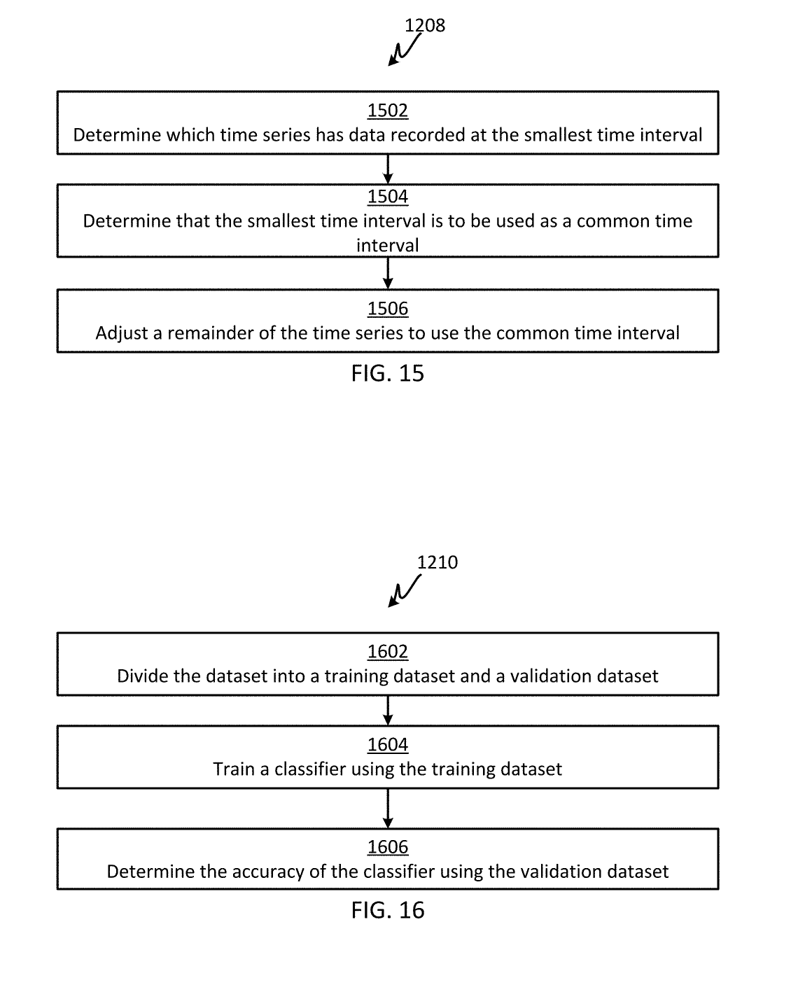

In some examples, the processor can generate the dataset by normalizing some or all of the time series associated with the multiple sensors to use a common time interval. For example, the Sensor01-Sensor05 shown in table 1400 may not all take sensor measurements at the same time interval. As a particular example, Sensor01 may take a sensor measurement every 30 seconds while Sensor02 may take a sensor measurement every minute. This may result in a time series associated with Sensor01 having double the amount of data points than a time series associated with Sensor02, which in turn may lead to gaps in table 1400 for Sensor02. It may be desirable to normalize all of the time series to use a common time interval so that all of the time series for all of the sensors have the same number of data points (e.g., to eliminate gaps in the table 1400 of FIG. 14). In some examples, the processor can adjust a time series to use a particular time interval by performing one or more of the operations shown in FIG. 15.

In block 1502, the processor determines which time series has data recorded at the smallest time interval. For example, the processor can analyze a first time series associated the target sensor and determine that the first time series has a first time interval of 30 seconds between each sensor measurement. The processor can also analyze a second time series associated with another sensor and determine that the second time series has a second time interval of one minute between each sensor measurement. The processor can compare the first time interval to the second time interval to determine that the first time interval is smaller than the second time interval. The processor can repeat this process for every time series associated with every sensor to identify the time series that has the smallest time interval between sensor measurements.

In block 1504, the processor determines that the smallest time interval is to be used as a common time interval. For example, the processor can determine that all of the time series, other than the time series with the smallest time interval, are to be adjusted so that the time interval between each sensor measurement is the smallest time interval.

In block 1506, the processor adjusts some or all of the time series associated with some or all of the sensors to use the common time interval. For example, the processor can include new data points in a time series so that the time interval between each data point in the time series is equal to the common time interval.

In some examples, the processor can set a magnitude for a new data point to be an average magnitude-value associated with the time series, a previous magnitude-value for immediately prior data point, or a subsequent magnitude-value for an immediately subsequent data point. For example, the processor can determine that an average magnitude-value for some or all of the data points in a time series is 1.2, and use 1.2 as the magnitude for a new data point. The processor can repeat this process for some or all of the new data points in an adjusted time series.

Returning back to FIG. 12, in block 1210 the processor generates a model using the dataset. The model can represent a relationship between the sensor measurements from some or all of the secondary sensors and the component values (i.e., the magnitude values for the particular component of the time series associated with the target sensor).

More specifically, the sensor measurements from the multiple sensors can depend on one another. This dependency can result in the sensor measurements from the secondary sensors influencing (e.g., contributing to) or otherwise being related to the sensor measurements from the target sensor. This relationship, in turn, can result in the sensor measurements from the secondary sensors influencing or otherwise being related to the component values. Otherwise stated, the sensor measurements from the secondary sensors can be independent variables that influence component values.

The sensor measurements from the secondary sensors can influence the component values to different degrees. The degree to which sensor measurements from a particular secondary sensor influences the component values can be represented as a weight. The processor can determine and assign respective weights to each of the secondary sensors. The weights for each of the secondary sensors can form at least a part of a model that represents how the secondary sensors influence the component values.

In some examples, the processor can determine the model, the weights for each of the secondary sensors, or both of these by performing Chi-square correlation on the dataset, a regression analysis on the dataset, by training a classifier (e.g., a random-forest classifier, a Naïve-bias classifier, a decision tree, a regression model, a neural network, etc.) using the dataset, or any combination of these. For example, the processor can perform a logistic regression on the dataset to determine an equation representative of a relationship between the sensor measurements from the secondary sensors and component values, where the equation includes respective weights for each of the secondary sensors.

As another example, the processor can perform some or all of the operations of FIG. 16 to generate the model. Specifically, in block 1602 the processor can divide the dataset into a training dataset and a validation dataset. The processor can divide the dataset into the training dataset and the validation dataset according to a predetermined criterion or based on user input (e.g., indicating that 60% of the dataset is to be allocated as training data and 40% of the dataset is to be allocated as validation data). In block 1604, the processor can train a classifier using the training dataset. For example, the processor can provide the training dataset as input to the classifier. In block 1606, the processor can determine the accuracy of the classifier using the validation dataset. For example, the processor can provide the validation dataset as input to the classifier and check the output of the classifier against a known, desired output. The processor can tune the classifier to correct for any observed discrepancies between the actual output from the classifier and the desired output from the classifier.

In some examples, the processor can generate multiple models (e.g., using any number and combination of the abovementioned methods). Each respective model can represent a respective relationship between (i) the sensor measurements from the secondary sensors and (ii) magnitude values for a particular component (e.g., a cycle component, seasonal component, trend component, irregular component, etc.) of the time series associated with the target sensor.

Returning to FIG. 12, in block 1212, the processor receives additional sensor measurements from some or all of the secondary sensors. For example, after the model is generated and configured, the processor can receive additional sensor measurements from some or all of the secondary sensors and store these sensor measurements in memory.

In block 1214, the processor uses the model to determine a predicted magnitude-value for the particular component of the time series associated with the target sensor based on the additional sensor-measurements. For example, the model can be a classifier. The processor can provide the additional sensor-measurements as inputs into the classifier and receive a predicted component-value as an output from the classifier. As another example, the model can be an equation generated using regression analysis. The processor can use the additional sensor-measurements as values for variables in the equation to determine the predicted component-value. The processor can use any number and combination of techniques (and models) to predict magnitude values for any number and combination of components of the time series associated with the target sensor.

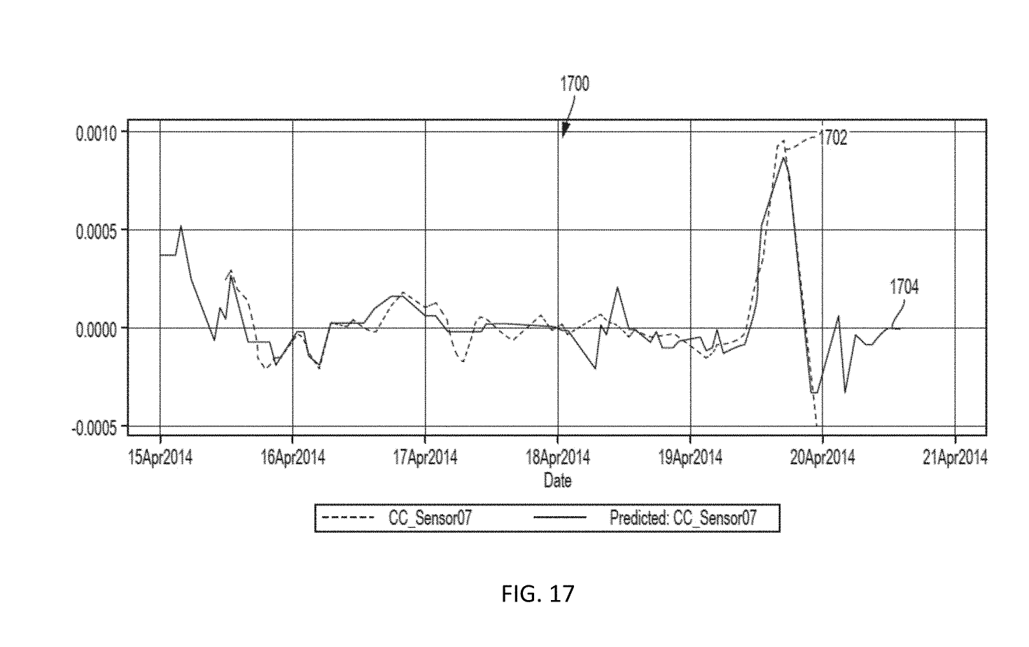

The processor can use the model to predict magnitude values for the component value, rather than actually calculate the magnitude values for the component value based on received sensor measurements from the target sensor. And the predicted magnitude values can have a high degree of accuracy. For example, turning to FIG. 17, graph 1700 includes one line 1702 representing actual magnitude-values for a cycle component of a time series and another line 1704 representing predicted magnitude-values for the cycle component. As can be seen, the predicted magnitude values are very close to the actual magnitude values, indicating that the predicted magnitude values have a high degree of accuracy.

Returning to FIG. 12, in block 1216, the processor identifies the anomaly with the machine based on the predicted magnitude value for the particular component. In some examples, the processor can compare the predicted magnitude value for the particular component to magnitude values stored in memory and known to be indicative of certain anomalies. A user, distributer, manufacturer, or installer may provide the magnitude values indicative of anomalies as input. If the predicted magnitude value for the particular component is within a certain tolerance range (e.g., +/− 0.1) of a magnitude value indicative of an anomaly, the processor can determine that the machine is experiencing the anomaly.

In some examples, the processor can compare the predicted magnitude value to a threshold value associated with an anomaly. The threshold value can be a predetermined threshold value (e.g., provided as input by a user, distributer, manufacturer, installer, etc.). In some examples, if the processor determines that the predicted magnitude value meets or exceeds the threshold value, the processor can determine that the machine is experiencing the anomaly. Alternatively, if the processor determines that the predicted magnitude value is below the threshold, the processor can determine that the machine is experiencing the anomaly.

In some examples, the processor can use the model to determine multiple predicted magnitude-values. The processor can compare the multiple predicted magnitude-values to a pattern of magnitude values known to be associated with an anomaly. The pattern of magnitude values can be a predetermined pattern of magnitude values provided as input by a user, distributer, manufacturer, installer, etc. and stored in memory. For example, the processor can analyze the multiple predicted magnitude-values to determine if they form a similar shape as (or have magnitude values within a preset tolerance range of) the pattern of magnitude values associated with an anomaly. For instance, the processor can determine if the multiple predicted magnitude-values include a high peak followed by a sharp dip, which can be a shape associated with the anomaly. If so, the processor can determine that, for example, the anomaly is occurring, has occurred, or will occur.

The processor can use any number and combination of techniques to determine if the machine is experiencing an anomaly, to identify the anomaly, or both of these. For example, the processor can determine that a predicted magnitude value is within a preset tolerance range of a magnitude value associated with a first type of anomaly. This condition may independently be indicative of the first type of anomaly. The processor can also determine that shape of multiple predicted magnitude-values is similar to (e.g., is within a predetermined degree of similarity to) a pattern of magnitude values associated with a second type of anomaly. This condition may independently be indicative of the second type of anomaly. Further, in some examples, the occurrence of both of these conditions together can be indicative of a third type of anomaly. The processor may determine that the machine is experiencing the third type of anomaly based on the presence of both of these conditions.

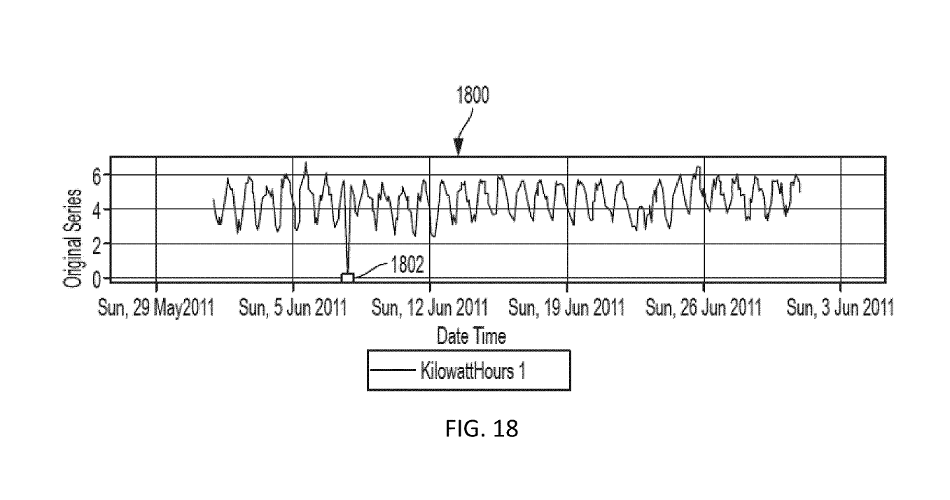

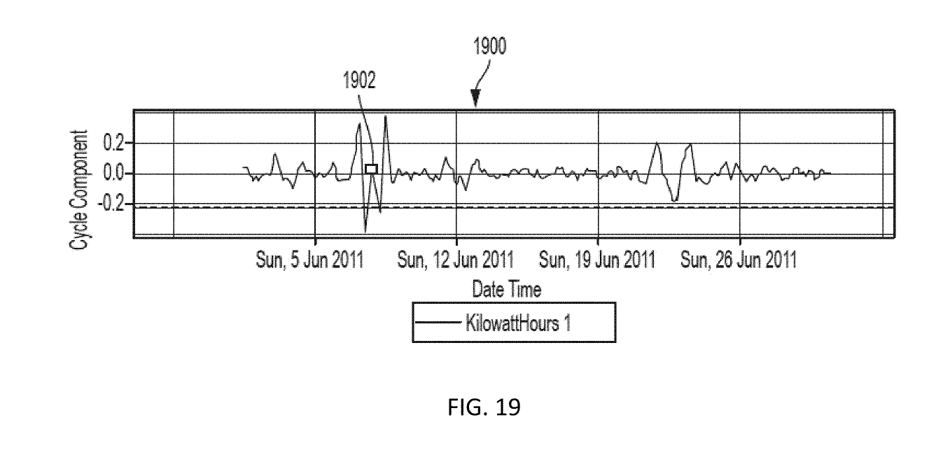

In some examples, analyzing the component values for a time series can result in earlier identification of potential anomalies. For example, FIG. 18 shows an example of a graph 1800 of sensor measurements from the target sensor. An anomaly occurred at point 1802. But this anomaly is only detectable at the time the anomaly actually occurs at point 1802. This can be time consuming, frustrating, and potentially dangerous for an operator of the machine, because the operator has no forewarning that the anomaly will occur. Conversely, FIG. 19 shows an example of a graph 1900 of cycle-component values associated with sensor measurements from the target sensor. The anomaly at point 1802 of FIG. 18 occurred at point 1902 in the graph 1900 of FIG. 19. As shown in the graph 1900, a large spike and dip occurred immediately prior to point 1902. This large spike and dip can signify to an operator that an anomaly is going to occur, thereby enabling the operator to take preventative action before the anomaly occurs. This type of forewarning can save an operator of the machine a significant amount of time and money.

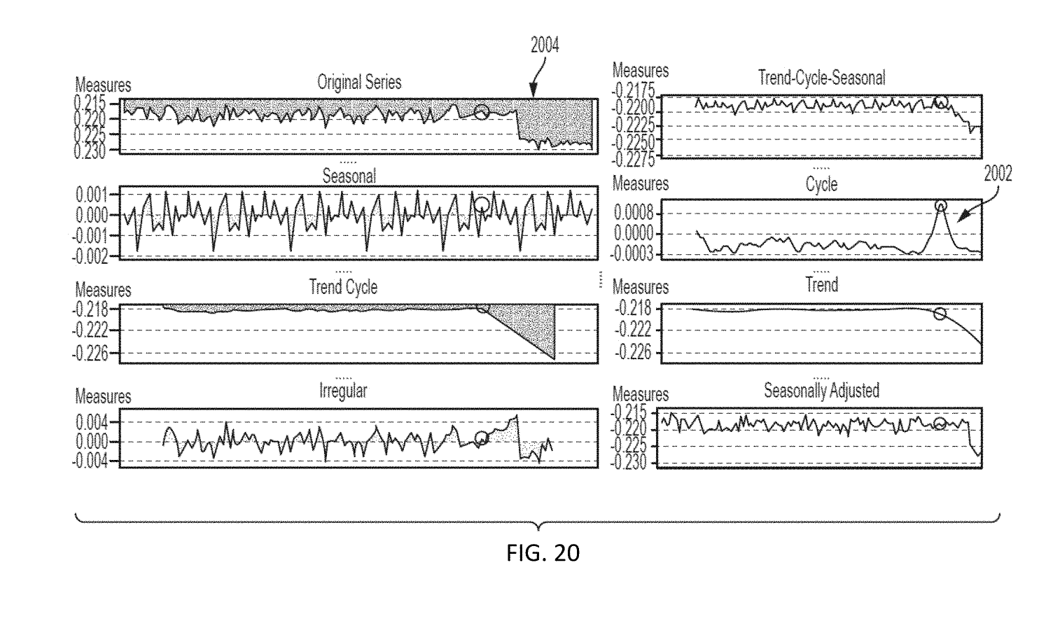

Another example comparing time-series values to corresponding component values is shown in FIG. 20. FIG. 20 shows the original time series in graph 2004. FIG. 20 also shows graphs for a seasonal component, trend-cycle component, irregular component, trend-cycle-seasonal component, cycle component, trend component, and seasonally adjusted component of the original time series. An anomaly occurred at the points on all the graphs that are circled. Although the anomaly is hard to detect in most of the graphs, there is a clear spike in graph 2002 (showing the cycle component of the time series) associated with the anomaly. The spike is clearly identifiable from the rest of the graph 2002. This may make the cycle-component a useful indicator of anomalies.

In block 1218, the processor outputs a notification indicative of the anomaly. For example, the processor can transmit a signal that causes a visual, haptic, or auditory notification to be output. The notification can indicate the presence of, type of, or other information about the anomaly. As a particular example, the processor can transmit a display signal to a display device (e.g., a liquid-crystal display) to cause the display device to output a notification indicating that an anomaly of a certain type is occurring. As another example, the processor can transmit an electronic communication to a remote computing device. The electronic communication can cause a display device of the remote computing device to output the notification. The processor can cause any number and combination of notifications to be output, having any information or combination of information related to the anomaly.

In block 1220, the processor performs an operation to avoid the anomaly or reduce the likelihood of the anomaly occurring. The operation can include any number and combination of sub-operations. Examples of the operation can include transmitting one or more commands to the machine (or another electronic device) to control or otherwise operate the machine (or the other electronic device). For example, the anomaly can be related to the machine overheating. To reduce the likelihood of the anomaly occurring, the processor can (i) shutdown the machine for a period of time; (ii) change a setting on the machine; (iii) put the machine into an idle state or another operational mode (e.g., that emits less heat); (iv) turn on an air conditioner, fan, or other cooling device to cool the machine; or (v) any combination of these.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

1. A system comprising:
a machine;
a plurality of sensors coupled to the machine for detecting characteristics of the machine;
a processing device communicatively coupled to the plurality of sensors; and
a memory device on which instructions executable by the processing device are stored for causing the processing device to:
receive sensor measurements from the plurality of sensors, the sensor measurements being usable as data points to form respective time series associated with respective sensors of the plurality of sensors;
determine a target sensor to monitor from among the plurality of sensors for detecting an anomaly with the machine;
determine magnitude values for a particular component of a time series associated with the target sensor by decomposing the time series into a plurality of components;
generate a dataset comprising the magnitude values for the particular component of the time series and the sensor measurements from the plurality of sensors;
generate a model using the dataset by assigning respective weights to each respective sensor of the plurality of sensors indicating how the sensor measurements from the respective sensor contribute to the magnitude values for the particular component of the time series associated with the target sensor, the model being representative of a relationship between (i) the sensor measurements from the plurality of sensors, and (ii) the magnitude values for the particular component of the time series associated with the target sensor;
receive additional sensor measurements from a subset of the plurality of sensors that excludes the target sensor;
use the model to determine a predicted magnitude value for the particular component of the time series associated with the target sensor based on the additional sensor measurements;
identify the anomaly with the machine by determining that (i) the predicted magnitude value of the particular component meets or exceeds a predetermined threshold; or (ii) multiple predicted magnitude values for the particular component comprise a predetermined pattern that is indicative of the anomaly; and
based on identifying the anomaly, output a notification indicative of the anomaly.

2. The system of claim 1, wherein the particular component of the time series is at least one of a cycle component, a seasonal component, a trend component, or a noise component.

3. The system of claim 2, wherein the memory device further includes instructions that are executable by the processing device for causing the processing device to perform an operation configured to reduce a likelihood of the anomaly occurring.

4. The system of claim 1, wherein the memory device further includes instructions that are executable by the processing device for causing the processing device to generate the dataset by creating a table having a plurality of entries, each entry of the plurality of entries comprising (i) a respective time; (ii) a respective magnitude value for the particular component of the time series at the respective time; and (iii) respective sensor measurements taken at the respective time by each of the respective sensors of the plurality of sensors.

5. The system of claim 1, wherein the memory device further includes instructions that are executable by the processing device for causing the processing device to generate the model using Chi-square correlation to determine the respective weights for each respective sensor of the plurality of sensors.

6. The system of claim 1, wherein the memory device further includes instructions that are executable by the processing device for causing the processing device to generate the model by performing a regression analysis using the dataset.

7. The system of claim 1, wherein the memory device further includes instructions that are executable by the processing device for causing the processing device to generate the model by:
dividing the dataset into a training dataset and a validation dataset;
training a classifier using the training dataset; and
determining an accuracy of the classifier using the validation dataset.

8. The system of claim 1, wherein the memory device further includes instructions that are executable by the processing device for causing the processing device to generate the dataset by normalizing the time series formed from the sensor measurements to use a common time interval by:
determining which respective time series has data recorded at a smallest time interval;
determining that the smallest time interval is to be the common time interval; and
adjusting a remainder of the time series to use the common time interval.

9. The system of claim 1, wherein the memory device further includes instructions that are executable by the processing device for causing the processing device to decompose the time series into the plurality of components by decomposing the time series using at least one of additive decomposition, multiplicative decomposition, an exponential-smoothing model, an autoregressive integrated moving-average model, an unobserved-components model, a singular spectrum analysis model, or an intermittent-demand model.

10. The system of claim 1, wherein the time series associated with the target sensor is (i) an intermittent time-series in which a majority of the magnitude values of the data points are zero, or (ii) a count series in which all of the magnitude values of the data points are non-negative integers.

11. A non-transitory computer readable medium comprising program code that is executable by a processing device for causing the processing device to:
receive sensor measurements from a plurality of sensors that detect characteristics of the machine, the sensor measurements being usable as data points to form respective time series associated with respective sensors of the plurality of sensors;
determine a target sensor to monitor from among the plurality of sensors for detecting an anomaly with the machine;
determine magnitude values for a particular component of a time series associated with the target sensor by decomposing the time series into a plurality of components;
generate a dataset comprising the magnitude values for the particular component of the time series and the sensor measurements from the plurality of sensors;
generate a model using the dataset by assigning respective weights to each respective sensor of the plurality of sensors indicating how the sensor measurements from the respective sensor contribute to the magnitude values for the particular component of the time series associated with the target sensor, the model being representative of a relationship between (i) the sensor measurements from the plurality of sensors, and (ii) the magnitude values for the particular component of the time series associated with the target sensor;
receive additional sensor measurements from a subset of the plurality of sensors that excludes the target sensor;
use the model to determine a predicted magnitude value for the particular component of the time series associated with the target sensor based on the additional sensor measurements;
identify the anomaly with the machine by determining that (i) the predicted magnitude value of the particular component meets or exceeds a predetermined threshold; or (ii) multiple predicted magnitude values for the particular component comprise a predetermined pattern that is indicative of the anomaly; and
based on identifying the anomaly, output a notification indicative of the anomaly.

12. The non-transitory computer readable medium of claim 11, wherein the particular component of the time series is at least one of a cycle component, a seasonal component, a trend component, or a noise component.

13. The non-transitory computer readable medium of claim 12, further comprising program code that is executable by the processing device for causing the processing device to perform an operation configured to reduce a likelihood of the anomaly occurring.

14. The non-transitory computer readable medium of claim 11, further comprising program code that is executable by the processing device for causing the processing device to generate the dataset by creating a table having a plurality of entries, each entry of the plurality of entries comprising (i) a respective time; (ii) a respective magnitude value for the particular component of the time series at the respective time; and (iii) respective sensor measurements taken at the respective time by each of the respective sensors of the plurality of sensors.

15. The non-transitory computer readable medium of claim 11, further comprising program code that is executable by the processing device for causing the processing device to generate the model using Chi-square correlation to determine the respective weights for each respective sensor of the plurality of sensors.

16. The non-transitory computer readable medium of claim 11, further comprising program code that is executable by the processing device for causing the processing device to generate the model by performing a regression analysis using the dataset.

17. The non-transitory computer readable medium of claim 11, further comprising program code that is executable by the processing device for causing the processing device to generate the model by:
dividing the dataset into a training dataset and a validation dataset;
training a classifier using the training dataset; and
determining an accuracy of the classifier using the validation dataset.

18. The non-transitory computer readable medium of claim 11, further comprising program code that is executable by the processing device for causing the processing device to generate the dataset by normalizing the time series formed from the sensor measurements to use a common time interval by:
determining which respective time series has data recorded at a smallest time interval;
determining that the smallest time interval is to be the common time interval; and
adjusting a remainder of the time series to use the common time interval.

19. The non-transitory computer readable medium of claim 11, further comprising program code that is executable by the processing device for causing the processing device to decompose the time series into the plurality of components by decomposing the time series using at least one of additive decomposition, multiplicative decomposition, an exponential-smoothing model, an autoregressive integrated moving-average model, an unobserved-components model, a singular spectrum analysis model, or an intermittent-demand model.

20. The non-transitory computer readable medium of claim 11, wherein the time series associated with the target sensor is (i) an intermittent time-series in which a majority of the magnitude values of the data points are zero, or (ii) a count series in which all of the magnitude values of the data points are non-negative integers.

21. A method for performing real-time monitoring of a machine, the method comprising:
receiving sensor measurements from a plurality of sensors that detect characteristics of the machine, the sensor measurements being usable as data points to form respective time series associated with respective sensors of the plurality of sensors;
determining a target sensor to monitor from among the plurality of sensors for detecting an anomaly with the machine;
determining, by a processor, magnitude values for a particular component of a time series associated with the target sensor by decomposing the time series into a plurality of components;
generating, by the processor, a dataset comprising the magnitude values for the particular component of the time series and the sensor measurements from the plurality of sensors;
generating, by the processor, a model using the dataset by assigning respective weights to each respective sensor of the plurality of sensors indicating how the sensor measurements from the respective sensor contribute to the magnitude values for the particular component of the time series associated with the target sensor, the model being representative of a relationship between (i) the sensor measurements from the plurality of sensors, and (ii) the magnitude values for the particular component of the time series associated with the target sensor;
receiving, by the processor, additional sensor measurements from a subset of the plurality of sensors that excludes the target sensor;
using, by the processor, the model to determine a predicted magnitude value for the particular component of the time series associated with the target sensor based on the additional sensor measurements;
identifying, by the processor, the anomaly with the machine by determining that (i) the predicted magnitude value of the particular component meets or exceeds a predetermined threshold; or (ii) multiple predicted magnitude values for the particular component comprise a predetermined pattern that is indicative of the anomaly; and
based on identifying the anomaly, outputting, a notification indicative of the anomaly.

22. The method of claim 21, wherein the particular component of the time series is at least one of a cycle component, a seasonal component, a trend component, or a noise component.

23. The method of claim 22, further comprising performing an operation configured to reduce a likelihood of the anomaly occurring.

24. The method of claim 21, wherein generating the dataset comprises creating a table having a plurality of entries, each entry of the plurality of entries comprising (i) a respective time; (ii) a respective magnitude value for the particular component of the time series at the respective time; and (iii) respective sensor measurements taken at the respective time by each of the respective sensors of the plurality of sensors.

25. The method of claim 21, wherein generating the model comprises using Chi-square correlation to determine the respective weights for each respective sensor of the plurality of sensors.

26. The method of claim 21, wherein generating the model comprises performing a regression analysis using the dataset.

27. The method of claim 21, wherein generating the model comprises:
dividing the dataset into a training dataset and a validation dataset;
training a classifier using the training dataset; and
determining an accuracy of the classifier using the validation dataset.

28. The method of claim 21, wherein generating the dataset comprises normalizing the time series formed from the sensor measurements to use a common time interval by:
determining which respective time series has data recorded at a smallest time interval;
determining that the smallest time interval is to be the common time interval; and
adjusting a remainder of the time series to use the common time interval.

29. The method of claim 21, wherein decomposing the time series into the plurality of components comprises decomposing the time series using at least one of additive decomposition, multiplicative decomposition, an exponential-smoothing model, an autoregressive integrated moving-average model, an unobserved-components model, a singular spectrum analysis model, or an intermittent-demand model.

30. The method of claim 21, wherein the time series associated with the target sensor is (i) an intermittent time-series in which a majority of the magnitude values of the data points are zero, or (ii) a count series in which all of the magnitude values of the data points are non-negative integers.
